(19) United States
(12) Patent Application Publication
(10) Pub. No.: US 2009/0006267 A1
(43) Pub. Date: Jan. 1, 2009

(54) SYSTEMS AND METHODS FOR COMPLIANCE SCREENING AND ACCOUNT MANAGEMENT IN THE FINANCIAL SERVICES INDUSTRY

(75) Inventors: Scott Fergusson, Fort Wayne, IN (US); Bob Hollman, Fort Wayne, IN (US); Joseph Leahy, III, Fort Wayne, IN (US); Jennifer Purdue, Fort Wayne, IN (US); Thomas Rozman, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: INVESTIGO CORPORATION, Edina, MN (US)

(21) Appl. No.: 11/736,970

(22) Filed: Apr. 18, 2007

(51) Int. Cl. G06Q 40/00

(52) U.S. Cl. 705/36 R

(57) ABSTRACT

Systems and methods for assisting financial services firms in the suitability screening and management of customer accounts, including computer programs for implementing such systems and methods, are disclosed. An illustrative system for performing compliance and account management at a financial services firm can include a number of representatives each having a number of clients, a compliance department including a number of supervisors each having supervisory review over client accounts managed by the representatives, and a computer program that can be used to generate electronic account applications that can be transmitted directly to a fund company for the purchase of funds. The computer program can include a hierarchical rules engine that can be used to create electronic control hierarchies that facilitate principal review over accounts and trades generated by the representatives.

### FIELD

The present invention relates generally to the field of compliance screening and account management in the financial services industry. More specifically, the present invention pertains to systems and methods for assisting financial services firms in the compliance screening and management of customer accounts, including computer programs for implementing such systems and methods.

### BACKGROUND

Financial services firms are required to ensure that investors desiring to purchase financial products meet certain threshold financial qualifications and have investment goals that are commensurate with the investment. In the purchase of securities, for example, broker-dealers are often required to gather and collect information about their clients in order to determine whether a particular investment is suited to their unique financial situation, investment goals, and investment experience. Such information is often gathered manually during an oral interview process and/or in writing by completing a questionnaire, and typically includes gathering information such as the investor's age, investment experience, liquid net worth, net worth, annual income, tax bracket status, employment status and/or source of funds. Information regarding the investor's investment objectives is also gathered during the interview process to ensure that the investor's investment goals and risk tolerance are suited to the particular investment. The suitability information gathered by the broker-dealer may be used, for example, to ensure that an elderly investor with limited financial resources and low risk tolerance is not placed into an aggressive or speculative investment that is considered high risk.

The process of collecting account information from clients is often time consuming and expensive. In the securities industry, for example, such information is often collected manually by a registered representative, and is then sent in paper form to either a separate clearance firm and/or a back-office clearance department, which then reviews the client's account information for suitability and compliance with the investment criteria established by the broker-dealer, the fund company, as well as Federal and state securities laws. If during the compliance screening process an error occurs, or if more information is required from the client in order to complete a transaction, the broker-dealer firm may then flag the account, requiring further action on behalf of the broker-dealer prior to releasing the trade to the fund company. A “parked” account, for example, may require an approval or waiver from a broker-dealer manager, supervisor, and/or registered representative in order for the trade to proceed, which may take several days or even weeks.

The ability of those individuals responsible for client account screening to quickly and easily review account and trade information is often counterbalanced by the manual process in which many firms collect and process client information. The review process may be particularly problematic in larger firms, where there may be multiple levels of review hierarchy within the firm, and where there may be different departments and/or entities responsible for compliance. Accordingly, there is a need for automated solutions for compliance screening and account management in the financial services industry.

### BRIEF SUMMARY

The present invention pertains to systems and methods for assisting financial services firms in the screening and management of customer accounts, including computer programs for implementing such systems and methods. An illustrative system for performing compliance and account management by a financial services firm can include a number of representatives each having a number of clients, a back-office compliance department including a number of supervisors each having supervisory review over client accounts managed by the representatives, and a computer program that can be used to generate electronic account applications that can be transmitted directly to a fund company for the purchase of requested funds. In some embodiments, the computer program can include a hierarchical rules engine that can be used to create electronic control hierarchies to facilitate principal review over client accounts and trades.

An illustrative method of managing client accounts by a financial services firm can include the steps of creating an electronic data package using a computer program, the electronic data package including an account application containing account information for a client desiring to purchase funds through one or more fund companies associated with the financial services firm. Once created, the electronic data package can be transmitted to a supervisor within a compliance department of the financial services firm responsible for reviewing client accounts and trades. The supervisor may then review the account application for the presence of any errors or flags, and then provide an approval or rejection of the account. In certain embodiments, for example, the supervisor may screen the account application for compliance with the suitability rules of the fund, and prompt the representative to take further action, if necessary. Once the account application is determined to be in good order, the electronic data package including the account application can be transmitted in electronic form directly to the appropriate fund company for further processing and trade execution.

### BRIEF DESCRIPTION OF THE DRAWINGS

FIG. 1 is a schematic view of an illustrative system for performing compliance and account management of client accounts by a financial services firm;

FIG. 2 is a flow chart showing an illustrative method of managing client accounts using the illustrative system of FIG. 1;

FIG. 3 is a diagrammatic view showing illustrative functionality that can be provided to representatives via the representative interface of FIG. 1;

FIG. 4 is a diagrammatic view showing several illustrative application fields for creating applications using the representative interface of FIG. 1;

FIGS. 5A-5P are several screen shots showing an illustrative graphical user interface for the representative interface of FIG. 1;

FIG. 6 is a diagrammatic view showing illustrative functionality that can be provided to supervisors via the home office interface of FIG. 1;

FIGS. 7A-7N are several screen shots showing an illustrative graphical user interface for the home office interface of FIG. 1; and

FIG. 8 is a diagrammatic view showing an illustrative control hierarchy that can be created using the home office interface of FIG. 1.

### DETAILED DESCRIPTION

The following description should be read with reference to the drawings, in which like elements in different drawings are numbered in like fashion. The drawings depict selected embodiments, and are not intended to limit the scope of the invention. Although examples of various systems, methods, and interfaces are illustrated in the various views, those skilled in the art will recognize that many of the examples provided have suitable alternatives that can be utilized. In addition, while the illustrative systems and methods are described with respect to securities broker-dealers, it should be understood that many of the elements and steps described herein can be employed by other types of broker-dealers. Examples of other types of broker-dealers may include insurance broker-dealers, bank broker-dealers, futures broker-dealers, and commodities broker-dealers. Other financial services firms as well as other business entities may also utilize the systems, methods and programs described herein.

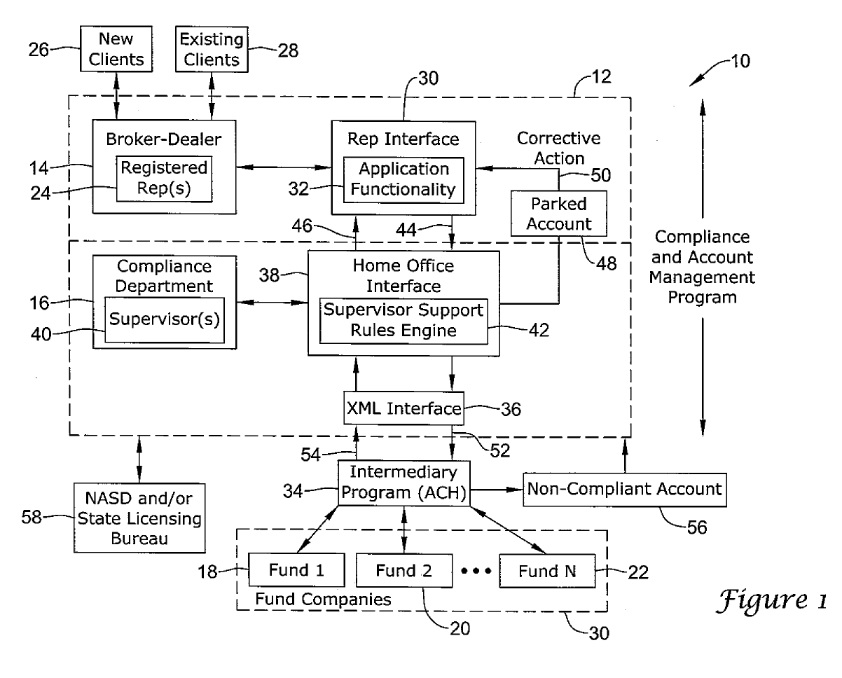

Referring now to FIG. 1, a schematic view of an illustrative system 10 for performing compliance and account management of client accounts by a financial services firm will now be described. As indicated generally by dashed lines in FIG. 1, the system 10 can include a compliance and account management computer program 12 that can be used by a broker-dealer 14 and a back-office compliance department 16 to create electronic accounts and perform suitability screening for investors desiring to purchase funds 18,20,22 directly from one or fund companies 30. The broker-dealer 14 may have, for example, one or more registered representatives 24 that desire to create new customer accounts for one or more new clients 26 requesting to purchase of securities or other financial products through one or more of the fund companies 30. The computer program 12 may also be utilized by the registered representatives 24 to update client accounts for one or more existing clients 28 wishing to purchase additional securities or other financial products through one or more of the fund companies 30. Funds 18,20,22 that can be purchased through the broker-dealer 14 may include securities such as mutual funds, public stocks, private stocks, bonds, options, variable contracts, and limited partnerships. The funds 18,20,22 may also include other financial products such as insurance annuities, commodities, and futures. The funds 18,20,22 may be provided through a single fund company, or through multiple fund companies. For example, fund 18 may represent an indexed mutual fund provided through an entity such as American Funds® whereas fund 20 may represent an annuity provided through a different entity such as Northwestern Mutual®.

The program 12 can be configured to operate as software and/or hardware on a network server or stand-alone computer, and can be accessed by each user of the program 12 via a personal computer, laptop computer, personal digital assistant (PDA), or other such computing device. In some embodiments, for example, the program 12 can be configured to run on a network server operated by the broker-dealer 14, which can be accessed by multiple users at one or more different locations via the Internet or an intranet connection. In use, account and trade information processed by the program 12, including those documents used in creating and executing such accounts and trades, can be stored in a secure database in communication with the network server.

In the illustrative embodiment of FIG. 1, the purchase of funds 18,20,22 can be made directly with the fund companies 30 and without the assistance of a clearing firm with the aid of an intermediary data aggregation program 34 such as DST Vision® or the like, which facilitates the viewing of account balances, account positions, transaction histories, fund pricing and yields, hypothetical back-end redemption charge calculations, as well as other desired information across multiple fund companies 30. The intermediary program 34 may also be used to facilitate householding and account aggregation across multiple fund companies 30, if desired. In some embodiments, for example, the intermediary program 34 may be used to facilitate suitability screening for the execution of trades across multiple fund companies 30 each having different criteria for purchasing their funds 18,20,22 and/or that have different interpretations of suitability rules for the purchase of their funds 18,202,22. Although data aggregation and suitability screening can be performed with the aid of an intermediary program 34 such as DST Vision®, it should be understood that one or more of these tasks can also be performed at the broker-dealer level using the broker-dealer computer program 12, if desired.

The program 12 may be linked to the intermediary program 34 via an extensible markup language (XML) interface 36, and can be implemented using an application programming interface (API) of the program 12 such as Microsoft Wind32 API or Java Platform, Enterprise Edition. In some embodiments, the intermediary program 34 may be used to facilitate changes in the central registration depository (CRD) numbers for the broker-dealer 14 and its registered representatives 24. The intermediary program 34 can also be used to link the broker-dealer 14 and its representatives 24 to a compensation system provided by one or more of the fund companies 30 to provide commissions for the purchase of any funds 18,20,22 requested by their clients 26,28. In some embodiments, the intermediary program 34 can be used to ensure that data collected and processed by the program 12 is matched between multiple applications.

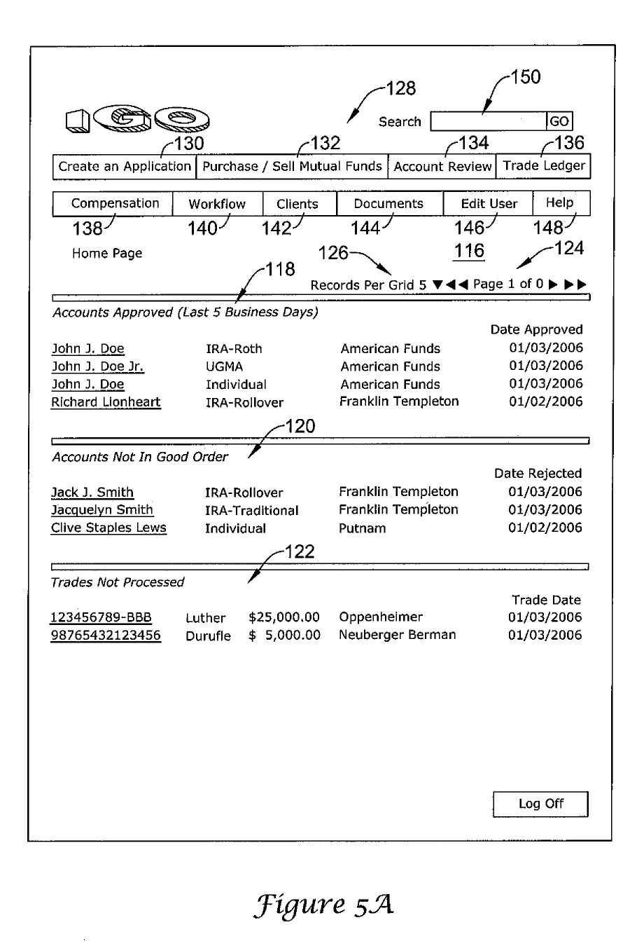

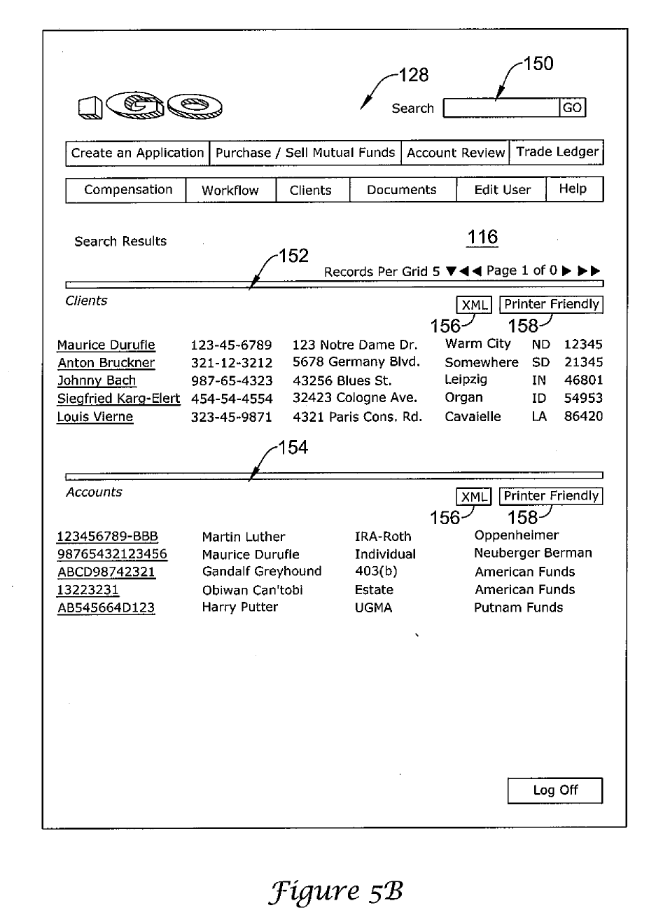

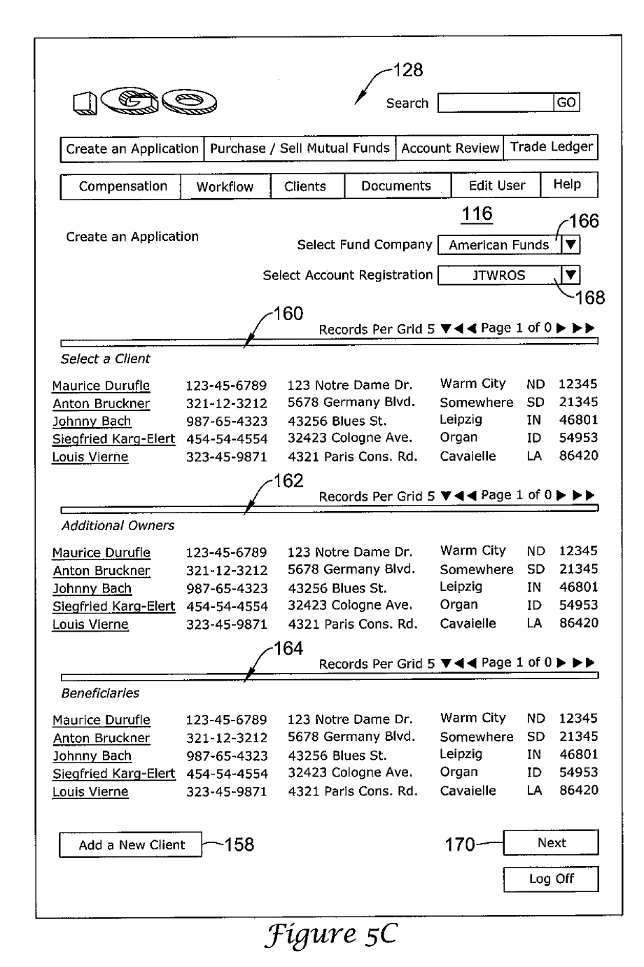

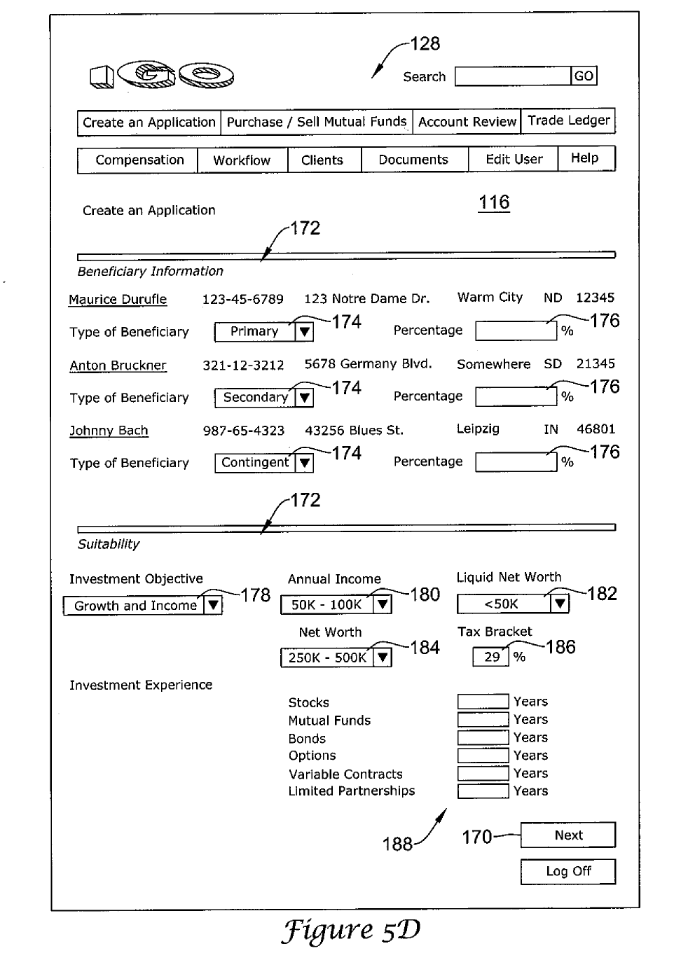

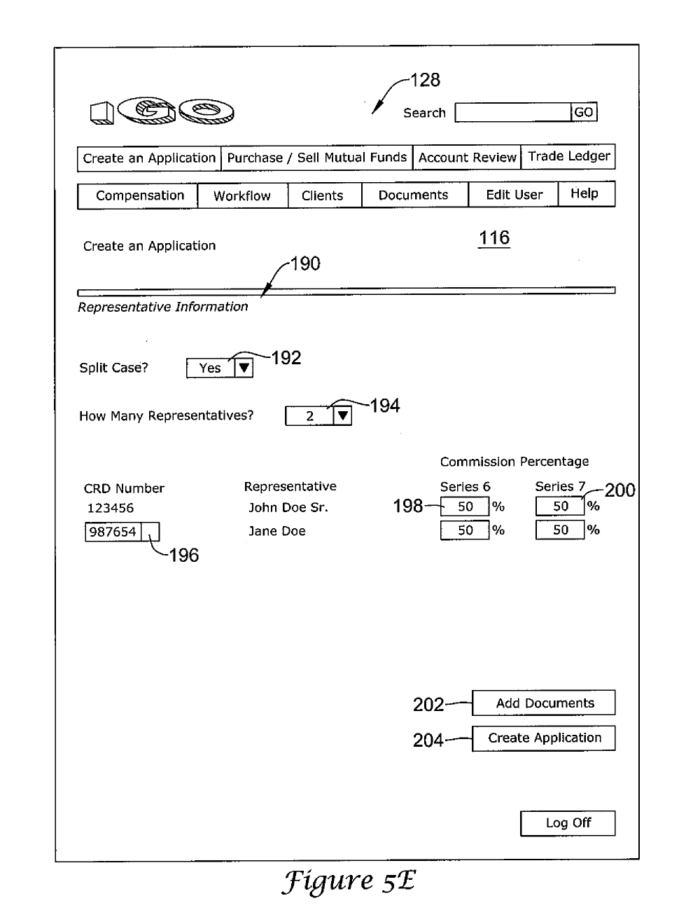

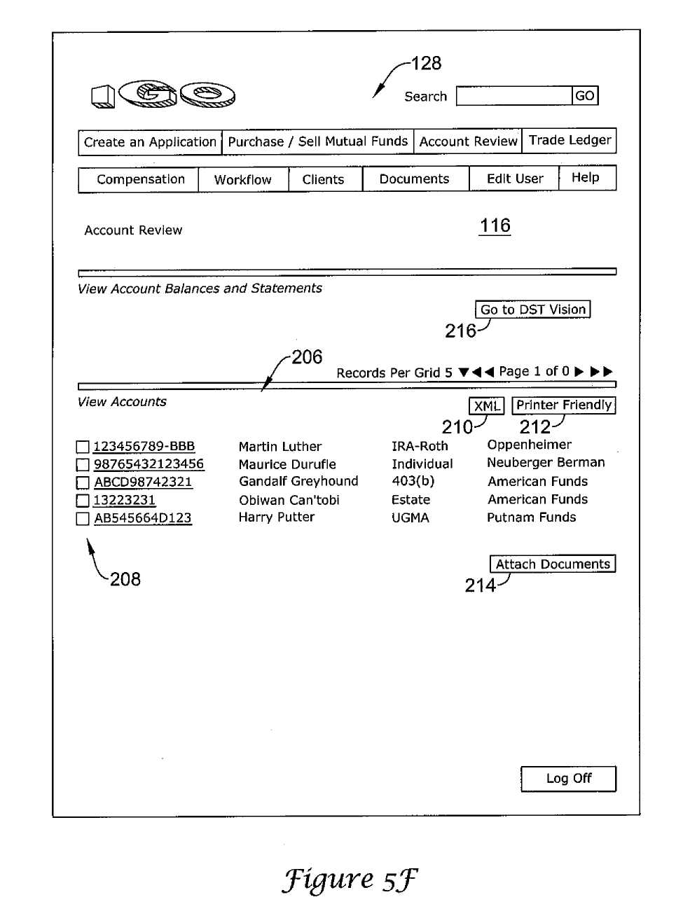

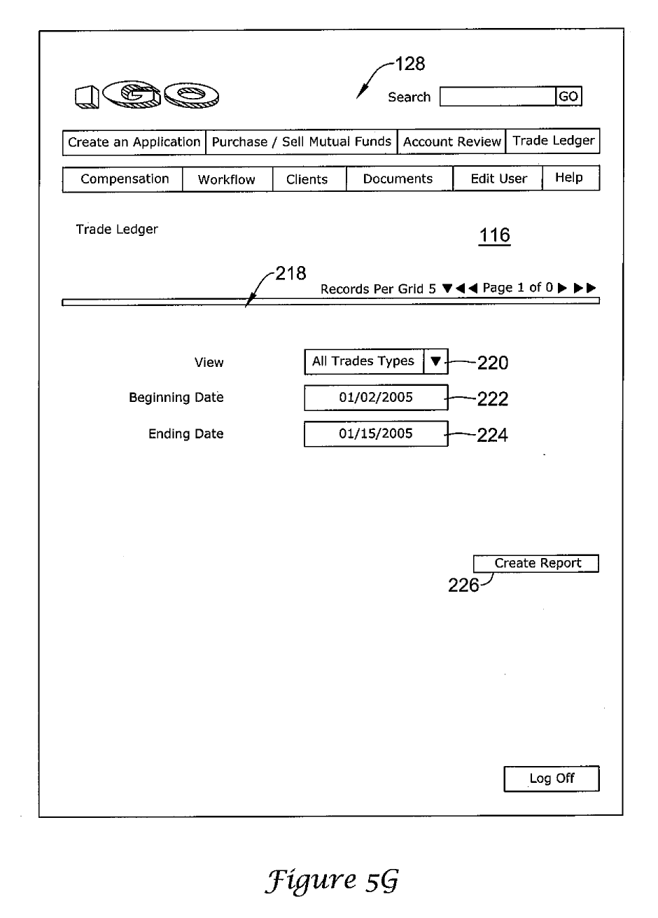

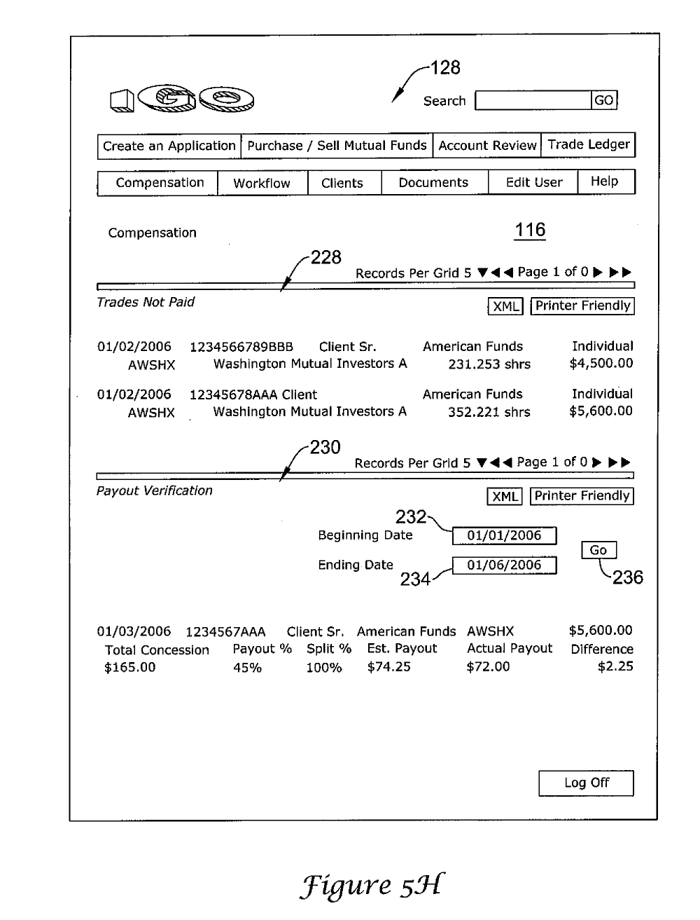

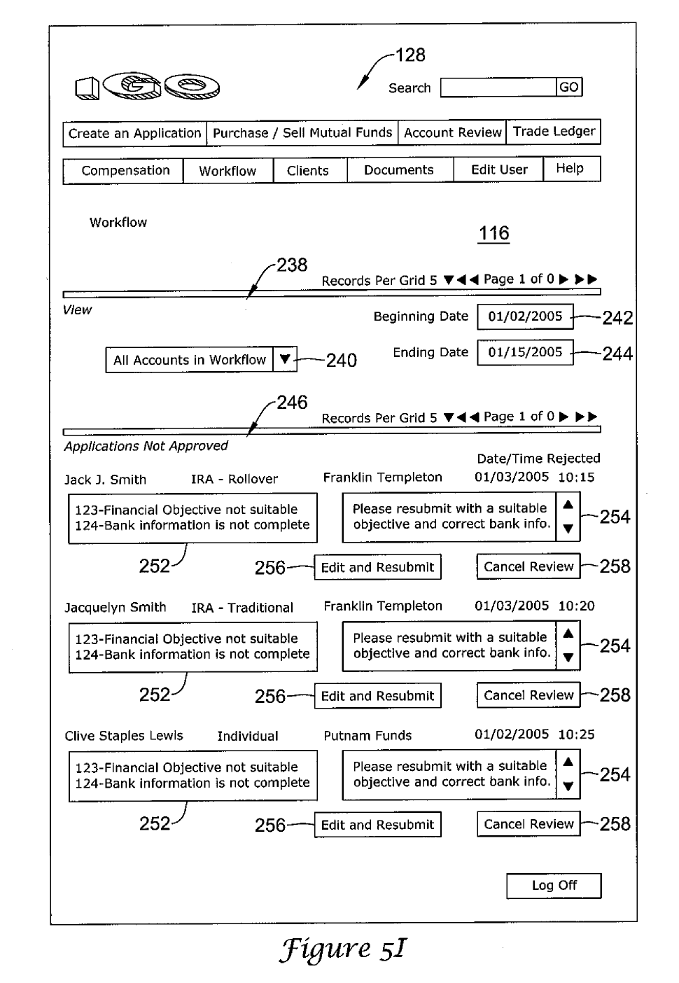

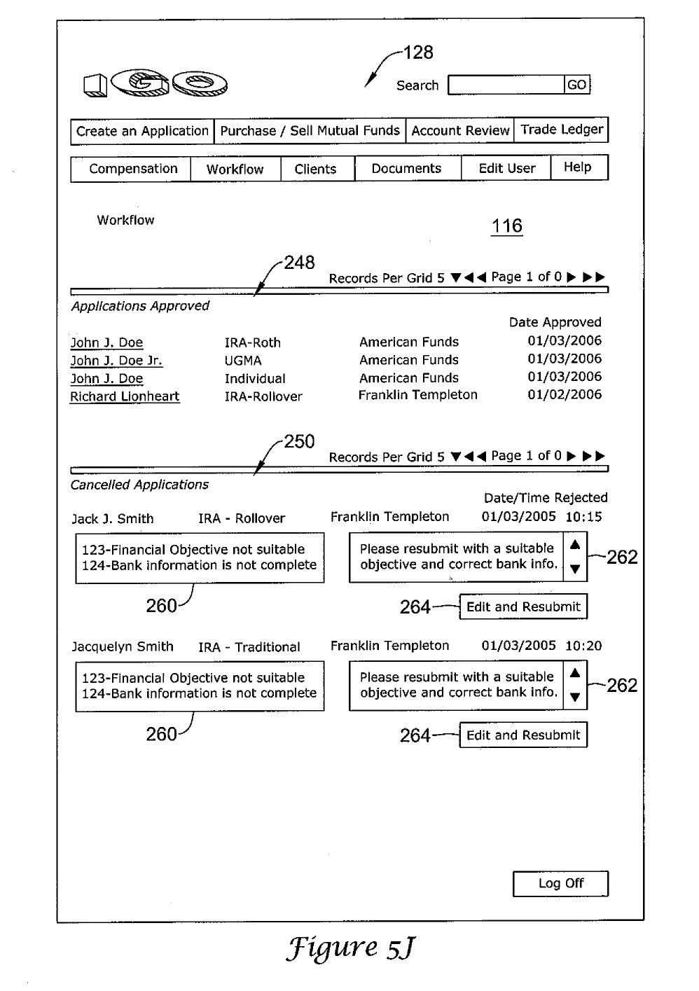

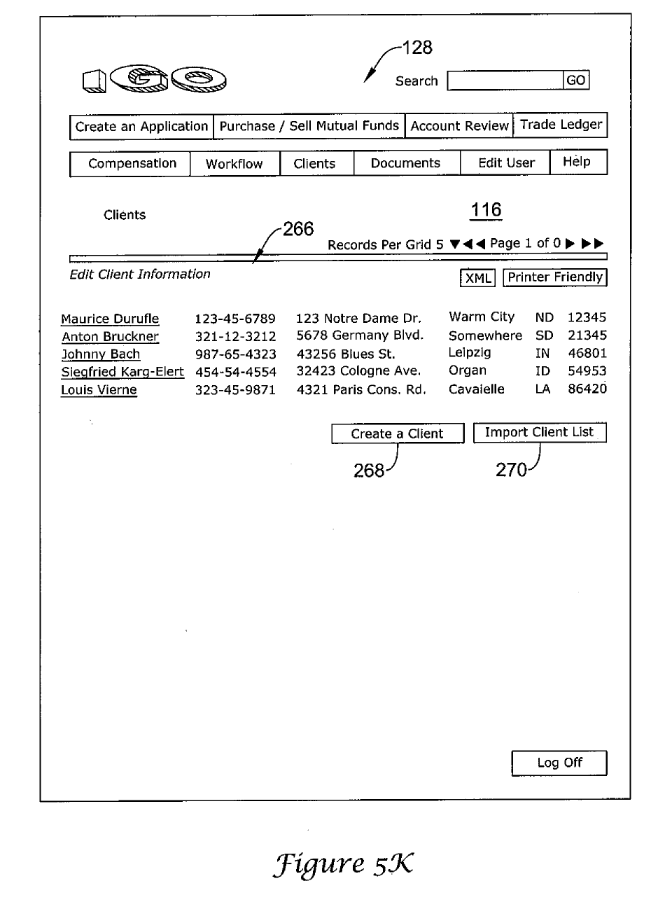

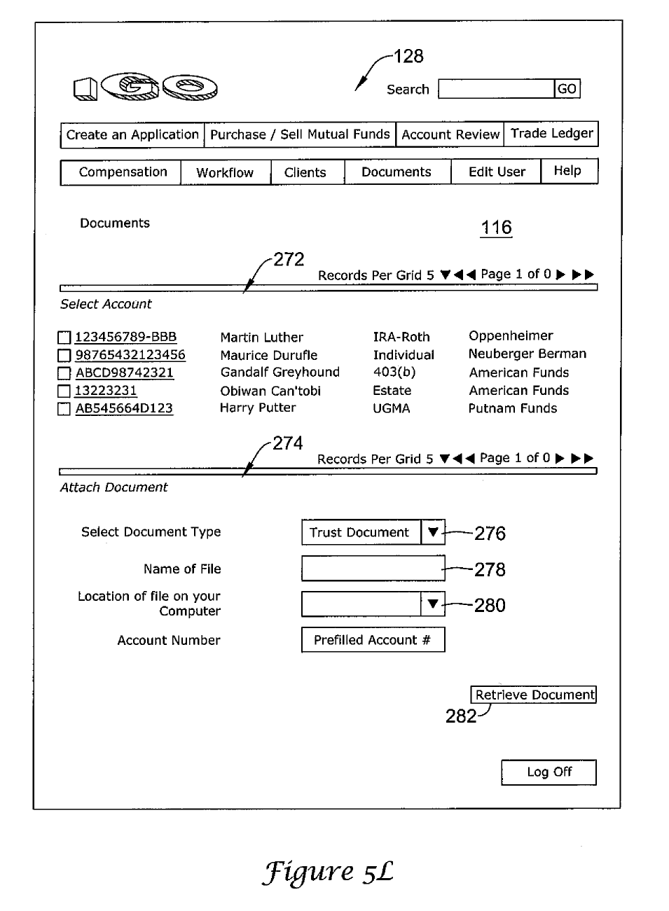

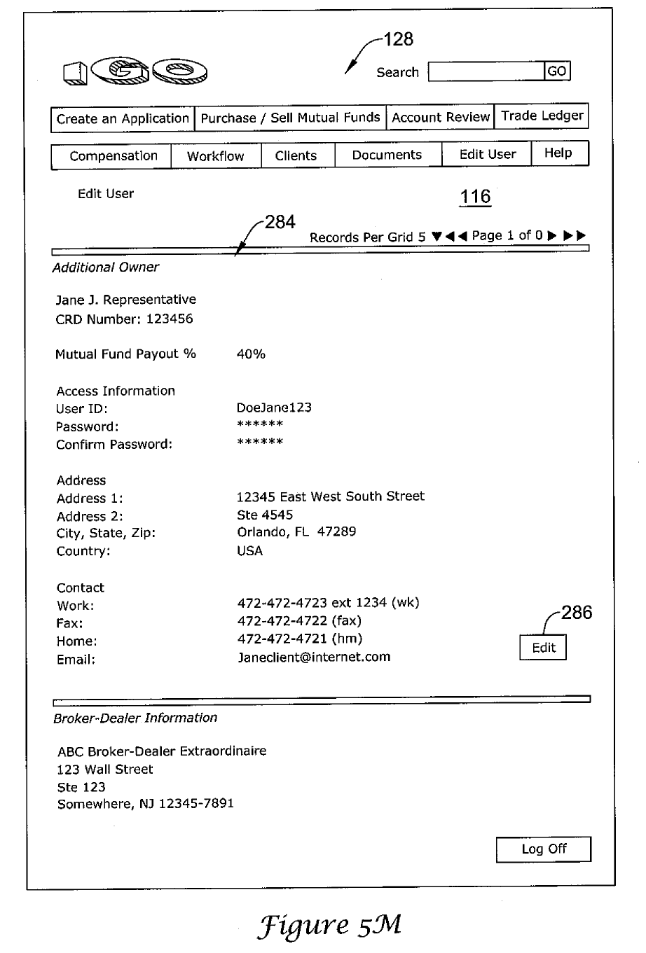

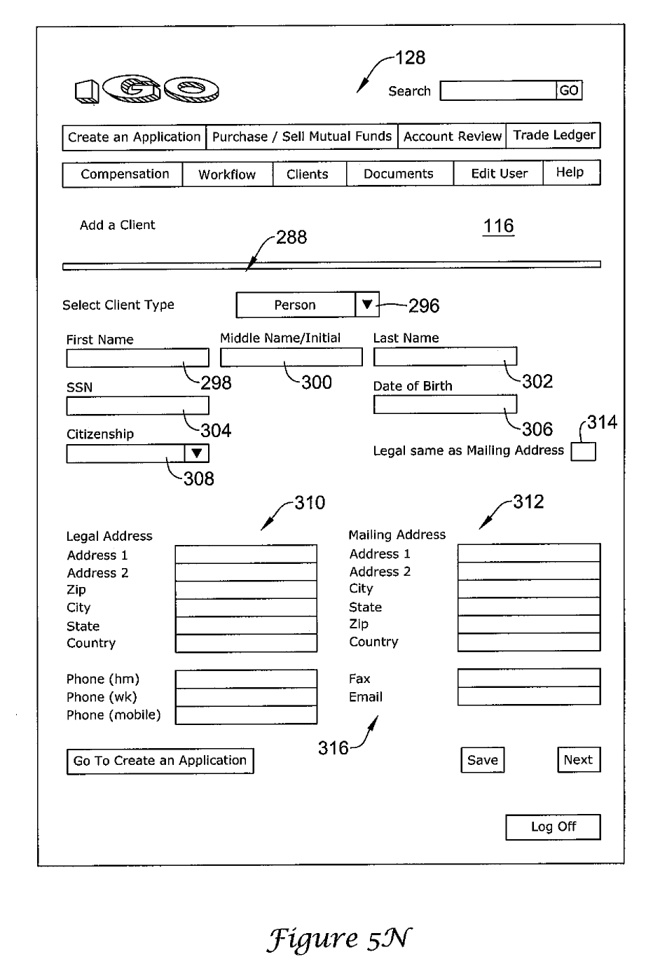

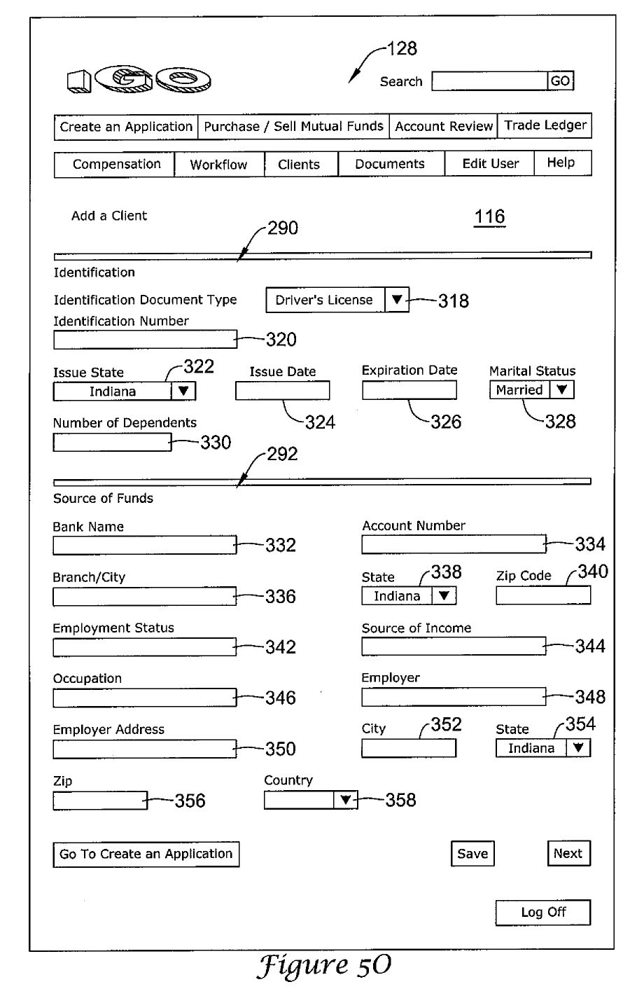

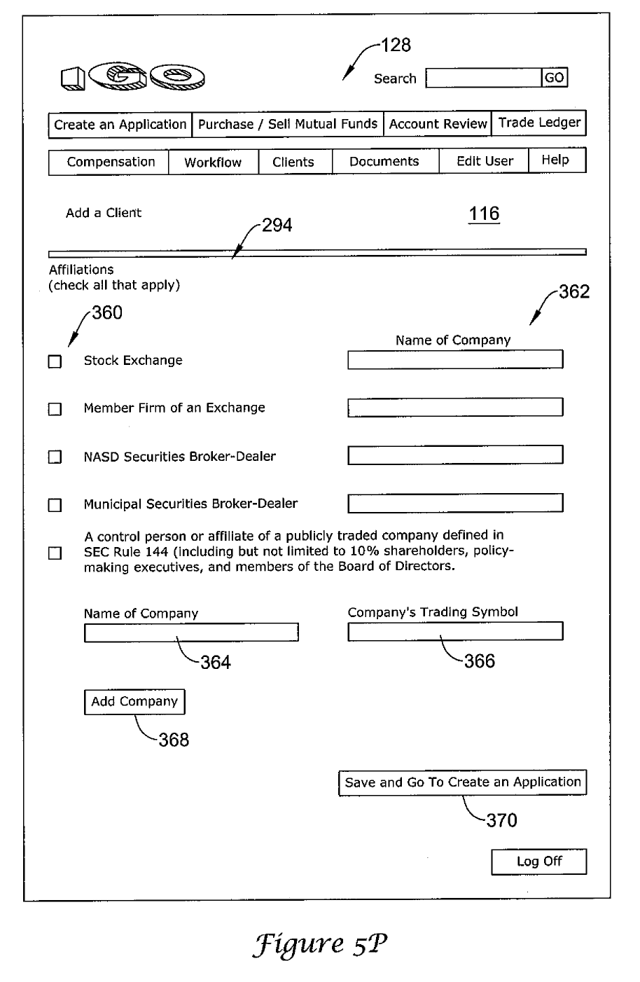

The program 12 may include a representative interface 30 that can be accessed by the representatives 24 to perform specific tasks or functions 32 at the representative level, including but not limited to, creating new customer accounts, executing trades, viewing client accounts for account status, updating existing client data, and viewing compensation exception reporting and the status of any commissions earned. The representative interface 30 may also be used to perform other representative functions 32 such as updating the representative's user profile, searching clients and/or accounts by representative, supervisor, office location, or other desired search string, constructing rules-based filters for both account and trade activity, performing principal review of trades and accounts, and providing trade functionality that includes appropriate rules and blotters. In some embodiments, the representative interface 30 may include a graphical user interface (GUI), allowing the representatives 24 to perform such tasks electronically using a computer equipped with a display screen. An illustrative GUI that can be provided as part of the representative interface 30 is further described herein with respect to FIGS. 5A-5P.

The representative interface 30 may also be used to perform householding functions for new and existing clients 26,28 desiring to purchase funds 18,20,22 through one or more fund companies 30. In some embodiments, for example, the representative interface 30 may be used to facilitate the collection of information necessary to satisfy the suitability criteria established for a particular fund 18,20,22. The representative interface 30 may also be used to collect additional information not required by the fund company 30. In some embodiments, for example, the representative interface 30 can be used to collect additional information for books and records not required by the find company 30, but which may be required by the specific broker-dealer 14 in order to open an account and/or execute a trade.

The program 12 may further include a home office interface 38 that can be accessed by one or more supervisors 40 to perform compliance functions relating to accounts for any new or existing clients 26,28 as well as any trade requests to be executed for those clients 26,28. The home office interface 38 may be used, for example, by a supervisor 40 such as a compliance manager or home office manager to perform suitability screening for those accounts established by their representatives 24 as well as the monitoring of trades and blotters for any trades executed by their representatives 24. Compliance functions that can be accomplished using the home office interface 38 can include, but are not limited to, workflow for account review, workflow for trades, licensing and reporting obligations, checking A share/B share issues, and monitoring any rights of accumulation. The home office interface 38 may also be used to provide alerts for any parked applications that become stale, or any problem trades that need to be resolved, either prior or after to submission to the fund company 30.

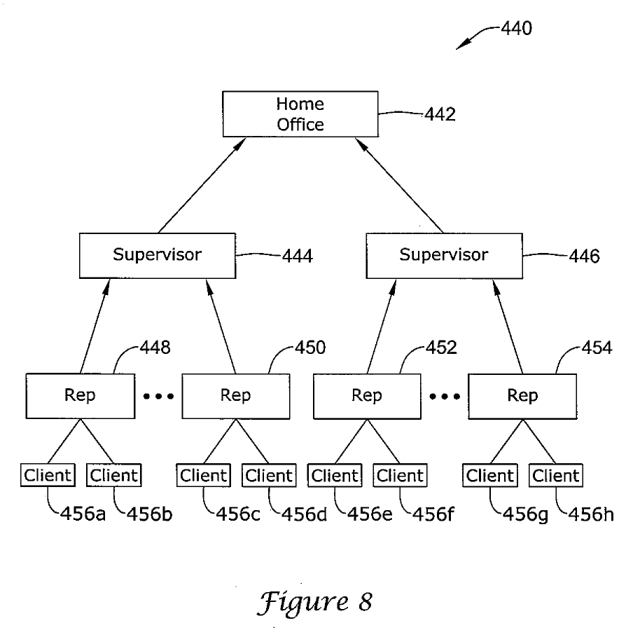

The home office interface 38 may further provide the supervisors 40 with the ability to access account information through the XML interface 36, which similar to the representative interface 30, allows the supervisors 40 to view account balances, account positions, transaction histories, fund pricing and yields, hypothetical back-end redemption charge calculations as well as other desired information across one or multiple fund companies 30. In some embodiments, and as further described herein with respect to FIG. 8, the home office interface 38 can be further utilized to create and maintain control hierarchies that can be used to more efficiently perform compliance duties across multiple representatives 24. In some embodiments, for example, the program 12 may include a rules engine 42 that can provide those supervisors 40 responsible for compliance duties with the ability to quickly and easily perform principal review over accounts and/or trades based on those representatives 24 responsible for those accounts and/or trades.

In some embodiments, the program 12 can be further linked to an NASD and/or state licensing database 58 to confirm the name and licensing status of the representative 24 and the broker-dealer 14 associated with the representative 24. The program 12 can be configured, for example, to update a list of the CRD numbers and licensing data for each registered representative 24, which can then be stored in an electronic database. The program 12 may update the list of licensed representatives 24 daily, weekly, monthly, continuously, or at some other desired interval. In use, the licensing information can be utilized by a supervisor 40 such as a compliance manager or home office manager to conduct licensing checks on all or select representatives 24 within the system 10.

The representative interface 30 can be customizable, allowing different types of information to be gathered by the representatives 24. In similar fashion, the home office interface 38 can also be customizable, allowing the program 12 to be modified for different types of financial services firms. For example, the home office interface 38 can be customized based on the particular manner in which suitability and/or compliance rules are interpreted, allowing compliance managers the ability to override or apply a different a rule interpretation to a particular client. In some embodiments, the program 12 can include a customization interface that facilitates the adaptation of the program 12 to the particular broker-dealer 14 and/or fund company 30.

In use, information gathered by the representatives 24 can be entered and stored electronically in a database using the representative interface 30. Once gathered, and as indicated generally by arrow 44, an electronic data package containing the account application and trade information along with control and confirmation numbers can then be fed to the compliance department 16 via the home office interface 38. The electronic data package can then be accessed by supervisors 40 to review the application to determine if there are any errors in the clean application, and to determine whether the client 26,28 meets the suitability rules established for the particular fund 18,20,22 and/or by the broker-dealer 14. The determination of whether an account is in good order can be made automatically by the program 12, or can be made manually by a supervisor 40 reviewing the account to ensure that the requirements for the particular fund 18,20,22 have been met. A confirmation that the account has been successfully reviewed and accepted by the compliance department 16 can then be fed back to the representative 24 via the representative interface 30 along with a date and time stamp indicating when the account application was accepted, as indicated generally by arrow 46.

If an error in the application is found, or if the investment criteria for purchasing the particular fund 18,20,22 sought has not been met, the program 12 can be configured to park the account 48 and prompt the representative 24 to take further corrective action, as indicated generally by arrow 50. The representative 24 may then make any necessary corrections to the parked application 48, as necessary.

Once an account has been successfully reviewed for the presence of any errors or flags, the account information and trade request may then be released to the appropriate fund company 30 via the intermediary program 34, as indicated generally by arrow 52. A confirmation that the trade was successfully processed along with a date and time stamp can then be sent back to the program 12 via the intermediary program 34, as indicated generally by arrow 54. The account can then be created and the trade processed by the fund company 30. An account number and trade confirmation can then be passed back through the intermediary program 34 to the program 12. Any money transactions can also be confirmed, as necessary.

If the account information and trade request transmitted to the intermediary program 34 is not accepted by the fund company 30, or if essential information is not provided in the reviewed application, the intermediary program 34 can be configured to return the non-compliant account application back to the program 12 for further processing and review, as further indicated generally by arrow 56. If, for example, the submitted application is disapproved because the client's 26,28 stated net worth does not meet the investment criteria established for the fund 18,20,22, the fund company 30 may reject the application, causing the intermediary program 34 to generate a notice of non-compliance that prompts the representative 24 and/or supervisor 40 to take further action on the account.

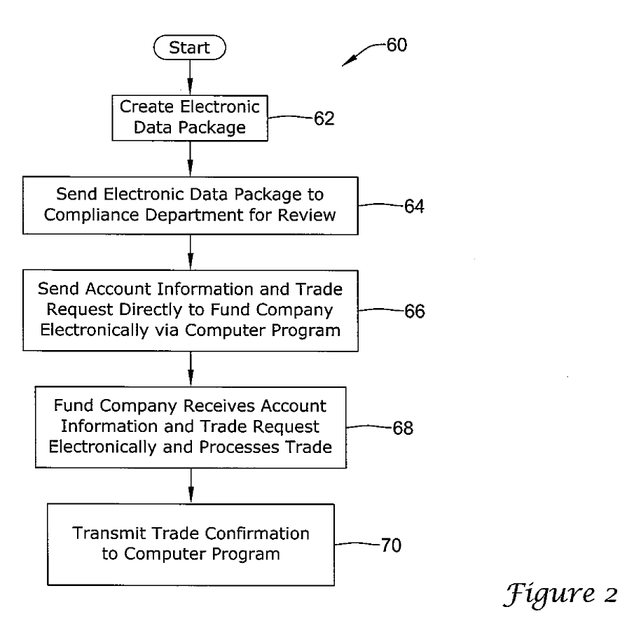

FIG. 2 is a flow chart showing an illustrative method 60 of managing client accounts using the illustrative system 10 of FIG. 1. The method 60 may begin generally at block 62 with the creation of an electronic data package containing information for each new and/or existing client 26,28 desiring to purchase funds 18,20,22 through one or more fund companies 30. The step at block 62 may be accomplished, for example, during an interview by a financial advisor or registered representative 24 in which the client 26,28 is asked several questions about their financial situation, investment experience, and investment goals. The information obtained during the interview process may then be entered as fields into the computer program 12, creating an electronic data package containing an account application. An illustrative process of creating an electronic data package is described further herein with respect to FIGS. 5C-5E.

Once an electronic data package containing a clean application has been created, the application along with a date and time stamp can then be sent to the compliance department 16 within the broker-dealer 14 for immediate review, as indicated generally at block 64. At this step, a supervisor 40 may then review the application to ensure that all required fields have been entered and that the client 26,28 meets the suitability criteria required to purchase the requested fund or funds 18,20,22. The review process may include, for example, the step of reviewing the application and trade request to ensure the client's age, investment experience, investment goals, liquid net worth, net worth, annual income, tax bracket status, as well as other suitability factors are commensurate with the investment criteria established by the fund 18,20,22 and/or the house rules established by the broker-dealer 14. If the trade is to be settled through an automated clearing house (ACH), the supervisor 40 may also review the ACH transaction data for accuracy. Any licensing checks on the representative 24 may also be performed at this step for compliance with federal and state licensing requirements.

If at step 64 the supervisor 40 determines that the clean application requires correction, or if the client does not meet the suitability standards for enrollment in the particular fund 18,20,22 requested, the account may be temporarily parked, and a message sent to the representative 24 in charge of the account to take corrective action to bring the account into compliance. If, for example, the supervisor 40 determines that the fund 18,20,22 sought to be purchased is unsuited to the client's stated investment goals, the supervisor 40 may park the account and send a message to the representative 24 prompting the representative 24 to review the accuracy of the client's stated goals.

Once the review process is complete and the application has cleared compliance screening, the program 12 can be configured to transmit the electronic data package directly to the appropriate fund company 30 for further processing, as indicated generally at block 66. When an intermediary program 34 such as DST Vision® is involved, for example, block 66 may include the step of converting the electronic data package into an XML format via the XML interface 36, and then transmitting the data package to the intermediary program 34 for further processing. If accepted, the funds are then processed and settled via the ACH, and the confirmation data for the requested trade is sent back to the program 12 acknowledging that the fund request has been submitted to the fund company 30.

Once the fund company 30 receives the account information and trade request from the intermediary program 34, the fund company 30 may then establish the account and process the trade, as indicated generally at block 68. The account number, trade confirmation, and ACH confirmation can then be transmitted back to the program 12, in some cases via the intermediary program 34, as indicated generally at block 70.

Since the data package is created, reviewed and transmitted electronically directly to the fund company 30 via the program 12, the speed at which the process occurs is shorter than in those systems that rely on generating account applications by paper and then mailing such information to the fund company for acceptance and processing. Moreover, because the program 12 may permit a broker-dealer 14 to place trades and clear funds directly instead of relying on a clearing house or other third-party intermediary, the time and cost associated with compliance screening may also be reduced. In some circumstances, for example, the ability of the clients 26,28 to invest in a desired fund 18,20,22 directly with the fund company 30 and in a straight-through manner electronically via the computer program 12 may provide for better price discovery since the trade executions and confirmations can occur more rapidly than with traditional systems, which often rely upon paper applications and the use of third-party clearance firms.

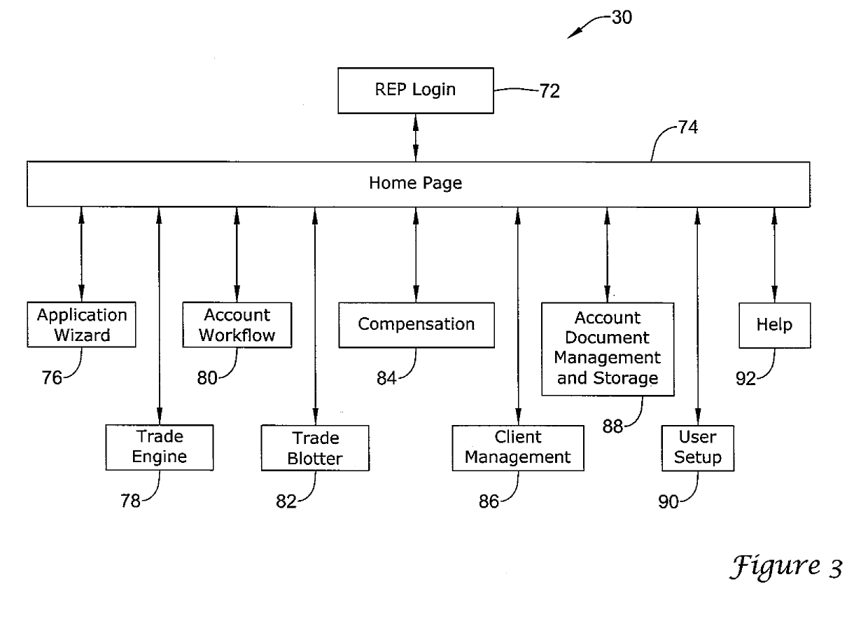

FIG. 3 is a diagrammatic view showing illustrative functionality that can be provided to representatives 24 via the representative interface 30 of FIG. 1. As shown in FIG. 3, the representative interface 30 can include a login screen 72 prompting the user to enter their CRD number, login name, and password to gain access to the application functionality 32 described above with respect to FIG. 1. The representative login screen 72 may be accessed, for example, by a representative 24 logging into their account via the Internet or an intranet connection. Once logged into their account, the program 12 can be configured to display a HOME PAGE screen 74 providing a list of accounts that have been recently approved, a list of accounts that have been parked or have been disapproved, and a list of trades that have not yet been processed. Other information may also be displayed on the HOME PAGE screen 74, if desired.

From the HOME PAGE screen 74, the user may access various program functionality, including an APPLICATION WIZARD module 76 for creating accounts, a TRADE ENGINE module 78 for creating trades, an ACCOUNT WORKFLOW module 80 for performing workflow on accounts, a TRADE BLOTTER module 82 for viewing trades and confirmations, a COMPENSATION module 84 for viewing compensation exception reporting, a CLIENT MANAGEMENT module 86 for viewing and updating client information, an ACCOUNT DOCUMENT MANAGEMENT AND STORAGE module 88 for uploading and storing documents, a USER SETUP module 90 for viewing and updating representative information, and a HELP module 92 for accessing various instructional and program training. Each module may represent, for example, a separate screen or screens on a graphical user interface (GUI) that can be accessed by the representative 24 via the representative interface 30.

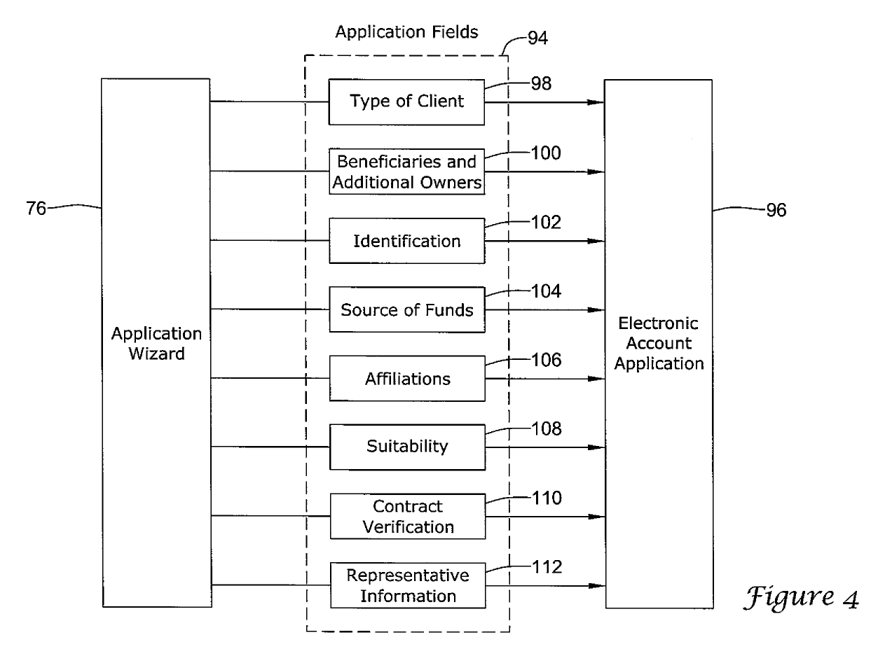

As can be further seen in FIG. 4, the APPLICATION WIZARD module 76 can be configured to prompt the user to enter various application fields 94 that can be used to create an electronic account application 96 for a new or existing client 26,28. The APPLICATION WIZARD module 76 may be initiated, for example, by selecting a button or series of buttons on the HOME PAGE screen 74, prompting the program 12 to present one or more display screens that can be used to enter client information for creating an electronic account application 96.

When the APPLICATION WIZARD module 76 is initiated, the program 12 can be configured to prompt the user to enter a TYPE OF CLIENT field 98 indicating the type of client for the application. If, for example, the application is for an individual client, the program 12 may prompt the user to enter the individual's full name, social security number, date of birth, citizenship, legal address, and contact information. For a corporate client, in turn, the program 12 may prompt the user to enter the organization name, tax identification number (TIN), the legal address and/or mailing address of the company, the name of a contact person responsible for the account, and contact information for the contact person. For a trust client, in turn, the program 12 may prompt the user to enter the trust name, a social security number (SSN) or tax identification number (TIN) associated with the trust, the name of the trustee, the date of birth of the trustee and/or any beneficiaries of the trust, the legal address and/or mailing address of the trust, and contact information for the trust.

A BENEFICIARY AND ADDITIONAL OWNERS field 100 may be used to select any beneficiaries that are to be associated with the electronic account application 96. Information that may be entered into this field 100 can include, for example, a beneficiary attribute field such as “primary beneficiary”, “secondary beneficiary”, “contingent beneficiary”, etc., the name of each beneficiary, the date of birth of each beneficiary, the mailing address of each beneficiary, and the percentage of claim to assets for each beneficiary. Similar information may be provided for any additional owners of the account, if desired. In some embodiments, the computer program 12 can be configured to determine whether the beneficiary attribute total is 100% and, if not, prompt the user to correct the percentage for one or more of the beneficiaries.

An IDENTIFICATION field 102 may be provided to permit the user to enter identification information required for creating the electronic account application 96. Identification information may include, for example, identification attributes for each owner such as a driver's license, a Federal and/or state ID, a passport, and/or other form of identification. For each form of identification used, an identification number, state or country of issuance, issue date, and expiration date may also be provided. Other identification information such as the owner's marital status and number of dependents may also be provided under this field 102. In some embodiments, such information may be utilized to conduct identity checks for compliance with identify screening under the U.S. Patriot Act or other such legislation.

A SOURCE OF FUNDS field 104 can be provided to specify the source of funds used in purchasing funds through the fund company. Examples of parameters that may be entered under this field 104 can include, but are not limited to, bank references for any bank accounts held by the client, the account numbers for those bank accounts, the branch or division in which the accounts are held, and the address of the bank. The program 12 may also prompt the user to enter information about the owner's current employment status (e.g. employed, unemployed, retired, etc.) and their source of income. If, for example, the client is an employed individual, the program 12 may prompt the user to enter data regarding the client's occupation, employer, and employer address. Conversely, if the client is a retired individual, the program 12 may prompt the user to enter data indicating whether the purchase of funds are being made from liquid assets held by the client, from the sale of another investment, or from some other source. Other information about the client's source of funds may also be specified using the SOURCE OF FUNDS field 104, if desired.

An AFFILIATIONS field 106 may be provided to associate any client affiliations with the representative managing the account. The AFFILIATIONS field 106 may be used by a broker-dealer, for example, to specify whether the client is a stock exchange, a member firm of a stock exchange, a National Association of Securities Dealers (NASD) securities broker-dealer, or a municipal securities broker-dealer. The AFFILIATIONS field 106 may also be used to specify the company's name, trading symbol, and a control person or affiliate of the company. If the company is publicly traded, for example, the computer program 12 may prompt the user to enter a control person or affiliate of the publicly traded company under SEC Rule 144, including, but not limited to, any 10% shareholders, policy-making executives, and members of the company's Board of Directors.

A SUITABILITY field 108 may be used to enter information that can be used to determine the client's suitability for purchasing particular funds. Example field parameters that may be entered under this field 108 can include, but are not limited to, the investment objective of the client, the client's annual income, the client's liquid net worth, the client's overall net worth, and the client's tax bracket. Information about the client's investment experience may also be entered under this field 108, including, for example, the number of year's experience the client has in stocks, mutual funds, bonds, options, variable contracts and limited partnerships. As with other fields, the type of information gathered under the SUITABILITY field 108 may vary depending on the investment criteria established for the find and the house rules of the broker-dealer. In some embodiments, for example, the SUITABILITY field 108 may be provided as a drop-down menu of the program 12, allowing the user to select between different interpretations of the suitability rules to be applied to a particular client.

A CONTRACT VERIFICATION field 110 may be used to select the types of signatures that are required for the electronic account application 96 as well as the manner in which verification of those signatures is accomplished. The types of required signatures that may be selected using this field 110 may include, for example, application signatures, arbitration signatures, withholding signatures, California clause signatures, as well as any specific signatures required by the broker-dealer. For each signature type, the user may select whether a signature is required, and if so, whether such signature can be made electronically or must be done by paper signature. The user may also select whether verification of the date of the signature is necessary.

A REPRESENTATIVE INFORMATION field 112 may be used to select information pertaining to the representative or representatives responsible for the account. Examples of parameters that may be entered under this field 112 can include, but are not limited to, the representative's name, the representative's CRD number, the signature of the representative, and the date in which the electronic account application 96 is created. In some cases, other information about the representative such as the percentage of commission for Series 6 and/or Series 7 business may also be specified under this field 112. Such percentages may then be verified by the program 12 to ensure that the sum of the percentages equals 100%.

If, during the application process, the program 12 detects an error in any one of the fields, the program 12 can be configured to display an error message on the user's display screen notifying the user of the error and prompting the user to take further corrective action, if necessary. For example, the program 12 may check the client's state of residence or incorporation against the representative's Series 7 license to determine whether the representative is licensed to sell securities in that state. The program 12 may also provide completion checks for client and account fields to ensure that there are no errors or flags. In the event an error or flag exists, the program 12 may provide the user with the ability to edit the application fields and resubmit the application 96.

Referring back to FIG. 3, the TRADE ENGINE module 78 can be used to create and review any trades to be executed. Example functions that may be performed via the TRADE ENGINE module 78 may include, but are not limited to, performing error checks and breakpoints on any trades, verifying available cash or source of funds for the trades and providing a method for any ACH deposits accompanying those trades, providing fund information such as contingent deferred sales charges (CDSC) for B shares or fund expense information, and receiving trade confirmations including date and time stamps indicating when the trades occurred. The TRADE ENGINE module 78 may also be used to perform other functions such as allowing exchanges of same share types, providing rules for “3:59:59” type trades, providing rules to prevent “after-hours” trading, and managing particular types of accounts such as those involving F-shares.

The ACCOUNT WORKFLOW module 80 can be used to perform various workflow tasks on client accounts. Example functions that can be performed using this module 80 can include, but are not limited to, viewing the rejected status of any accounts or trades, viewing the approved status of any accounts or trades, and viewing those accounts that have been temporarily suspended or parked in the review process. In some cases, the program 12 may further prioritize particular accounts, prompting the user to take immediate action on those accounts. For example, the program 12 may display a list of those accounts that have been parked for the longest period of time, or which have identified by the compliance department 16 as requiring immediate attention.

The TRADE BLOTTER module 82 can be used to view accounts and their current and prior status. Example functions that can be performed using this module 80 may include, but are not limited to, receiving any rejected account or trade confirmations, taking corrective action for any accounts or trades, and viewing any unmatched accounts and trades that have been accepted but not confirmed. If, for example, a trade request has been successfully sent to the fund company 30 but has not yet been confirmed, the program 12 can be configured to prompt the user to take further action on the account. Trade times, confirmation numbers, available funds, and other metrics may also be accessed via the TRADE BLOTTER module 82.

A COMPENSATION module 84 can be used to view compensation exception reporting and to specify any commissions to be generated for trades. The COMPENSATION module 84 may be used, for example, by a representative 24 to input the correct split percentage to be associated with the account and to code their user commission setting with the correct payout. The module 84 may be further used for comparing what commission is actually paid-out verses the anticipated commission generated for the trade. In some embodiments, the module 84 may provide a means to provide compensation integration with other back-office programs, if desired.

A CLIENT MANAGEMENT module 86 can be used by the representative 24 to view and update client information. For example, the CLIENT MANAGEMENT module 86 can be used to view and, if necessary update, a client's address, contact information, beneficiary information, investment objectives and risk tolerance, investment experience, source of income, as well as other desired information. In some embodiments, the module 86 may be used to access search and/or filtering capabilities of the program 12, allowing the user to search and/or filter clients based on one or more parameters. For example, the program 12 may include a search engine that can be accessed by the user to search for a client by name, to search for accounts that are parked or require additional workflow, to search for clients having a particular investment objective, and so forth. An example use of the search engine may be to search for those clients that have not designated a beneficiary, prompting the representative 24 to send out a reminder letter to those clients requesting that they submit a beneficiary form listing one or more primary or secondary beneficiaries to be associated with their account. The results of the search can be displayed in XML grid format, in a printer friendly format, or in some other format, as desired. In certain embodiments, the program 12 may include a filter control to permit the user to further filter the search results.

An ACCOUNT DOCUMENT MANAGEMENT AND STORAGE module 88 may be accessed by the user to view and upload any documents required by the broker-dealer 14 and/or the fund company 30. Examples of documents that may be viewed and, if necessary updated, can include the client's driver's license information, suitability questionnaire, tax documents, trust documents, etc. The types of documents to be uploaded will often depend on the type of client specified for the account, the house rules of the broker-dealer 14, as well as the specific rules provided by the fund company 30. If the user indicates that the client is a trust client, for example, the program 12 can be configured to prompt the user to upload any trust documents to be associated with the trust account, including those documents listing the trustee and any beneficiaries of the trust.

A USER SETUP module 90 may be used to view and update the user's personal and licensing information. Example functions that can be performed via the USER SETUP module 90 can include, but are not limited to, updating a representative's address, contact information, CRD number, login and passwords for access to the program 12, and to update any payout percentages to be associated with an account. If the representative is registered at multiple broker-dealers, the USER SETUP module 90 can also be used by the representative to display the broker-dealers on file by name and CRD number. Other user-related functions may also be accessed via the USER SETUP module 90, if desired.

A HELP module 92 can be used to obtain additional information regarding the program 12. For example, the HELP module 92 may be used to access an electronic user manual, view training videos on the functionality of the program 12, perform a quick review of the program 12, and to view a list of frequently asked questions (FAQ's). In some cases, additional instructional and/or training information for performing representative duties such as suitability screening can also be accessed via the HELP module 92, if desired.

FIGS. 5A-5P are several screen shots showing an illustrative graphical user interface (GUI) for the representative interface 30 of FIG. 1. FIGS. 5A-5P may represent, for example, a graphical user interface that can be accessed on a representative's computer, personal digital assistant (PDA) or other such device.

FIG. 5A is a screen shot showing an illustrative home page screen that can be displayed on the user's display screen 116. The home page screen may represent, for example, one or more display screens that can be presented to a representative 24 upon entering their user CRD number, user login name, and password. As shown in FIG. 5A, the program 12 can be configured to display a list 118 of those accounts that have been recently approved, a list 120 of those accounts that are not in good order and that require additional information from the representative, and a list 122 of those trades that have been requested but are not yet processed. If desired, additional information can also be provided on the display screen 116. A set of scroll icon buttons 124 can be used to scroll through each item on the display screen 116, allowing the representative 24 to view all items within each list 118,120,122. A second icon button 126 on the display screen 116, in turn, can be used to specify the number of records to be displayed on a single display screen within each list 118,120,122.

The program 12 can be configured to display an interactive toolbar 128 on the display screen 116 that can be used to access additional program functionality from the home page screen. The toolbar 128 may include, for example, a CREATE AN APPLICATION icon button 130 that can be used for creating electronic account applications, a PURCHASE/SELL MUTUAL FUNDS icon button 132 for creating trades, an ACCOUNT REVIEW icon button 134 for performing workflow on accounts, a TRADE LEDGER icon button 136 for viewing trades and confirmations, a COMPENSATION icon button 138 for viewing compensation exception reporting, a WORKFLOW icon button 140 for performing workflow on accounts, a CLIENTS icon button 142 for viewing and updating client information, a DOCUMENTS icon button 144 for uploading and storing documents, an EDIT USER icon button 146 for viewing and editing information about the representative, and a HELP icon button 148 for providing the representative with instructional and program training. In some embodiments, the icon buttons on the toolbar 128 may be used to provide functionality similar to that described above with respect to FIG. 3.

The program 12 can be configured to display a text search box 50 that can be used to facilitate searching for certain clients and/or accounts. In certain embodiments, for example, the text search box 150 may be used to search accounts and/or trades by client name, beneficiary name, account number, account type, or other such searching criteria. If, for example, the representative 24 desires to search those accounts in which the client name is “John J. Doe”, the representative 24 may enter all or a portion of the client's name into the text search box 150, prompting the program 12 to search those accounts and/or trades containing that name.

FIG. 5B is a screen shot showing the search results of an illustrative search performed using the text search box 150. As shown in FIG. 5B, the program 12 can be configured to display a list 152 of clients and a list 154 of accounts matching the search text entered into the text box 150. The results of each list 152,154 generated by the search can be selected for display in either an XML grid format via icon button 156, or a printer-friendly format via icon button 158.

FIGS. 5C-5E are several screen shots showing the display screen 116 upon the selection of the CREATE AN APPLICATION icon button 132 on the toolbar 128. As shown in a first screen shot depicted in FIG. 5C, for example, selection of icon button 132 may prompt the program 12 to display a list 160 of clients, a list 162 of additional owners, and a list 164 of beneficiaries. If desired, additional information in addition to, or in lieu of that depicted in FIG. 5C may be provided on the display screen 116.

To create a new account from an existing client, owner, and/or beneficiary, the representative 24 may select the desired name on the display screen 116, prompting the program 12 to automatically fill in several fields in the application including the individual's name, address, and contact information. Conversely, if the representative desires to open an account with a new client, the representative may select an ADD NEW CLIENT icon button 158 on the display screen 116, allowing the representative to add the name, address, contact information for the new client. A SELECT FUND COMPANY selection bar 166 and a SELECT ACCOUNT REGISTRATION selection bar 168 provided on the display screen 116 can be used to select the fund company and the type of account to be created. If, for example, the application is for the purchase of mutual funds to be registered as a joint trust with right of survivorship (JTWROS) account, the representative may select the appropriate entries on the display screen 116 using the selection bars 166,168, as shown.

FIG. 5D is a screen shot showing an illustrative application screen that can be used to input the beneficiaries to be associated with the account and suitability information required by the fund company 30 and/or broker-dealer 14 for suitability screening. The screen depicted in FIG. 5D may be accessed, for example, by selecting a NEXT icon button 170 on the prior display screen. As shown in FIG. 5D, for each client listed in section 172, a TYPE OF BENEFICIARY selection bar 174 may be used to enter the type of beneficiary (e.g. primary, secondary, contingent, etc.) for each beneficiary to be designated in the application. A PERCENTAGE icon box 176 may also be provided for each beneficiary in order to designate the percentages for each beneficiary.

A SUITABILITY section 176 on the display screen 116 can be used to enter information necessary to perform suitability screening for the client. An INVESTMENT OBJECTIVE selection bar 178 can be used to enter the client's investment objective. For example, if the client's stated investment objective is growth and income, the representative may select the appropriate text under the selection bar 178. An ANNUAL INCOME selection bar 180, LIQUID NET WORTH selection bar 182, and NET WORTH selection button 184 can be provided to permit the representative to enter the client's financial wherewithal to purchase the requested funds. A TAX BRACKET selection bar 186, in turn, can be used to enter the client's most recent tax bracket based on the client's prior tax return. A number of INVESTMENT EXPERIENCE text boxes 188 can be provided to permit the user to enter the number of years investment experience the client has in investing in particular funds. For example, the text boxes 188 can be used to enter the number of years investment experience the client has in investing in stocks, mutual funds, bonds, options, variable contracts, and/or limited partnerships, as shown. Other information required by the fund company 30 and/or the broker-dealer 14 may also be entered using the SUITABILITY section 176.

FIG. 5E is a screen shot showing an illustrative screen that can be used by the representative to enter those representatives that are to be associated with the account. As shown in FIG. 5E, a REPRESENTATIVE INFORMATION section 190 on the display screen 116 can include a SPLIT CASE selection bar 192 to indicate whether commissions are to be split, and a NUMBER OF REPRESENTATIVES selection bar to indicate the number of representatives earning commissions. A CRD NUMBER text box 196 may be provided to indicate the representative or representatives to be associated with the application. For each representative entered and displayed on the display screen 116, the program 12 may prompt the representative to enter the percentage of commission for Series 6 and/or Series 7 business using a number of respective text boxes 198,200, as shown.

Once the representative is finished filling in the required fields on the application, the representative may then select an ADD DOCUMENTS icon button 202 to add any documents that are required for the application. Otherwise, the representative may select a CREATE APPLICATION icon button 204 on the display screen 116, prompting the program 12 to create the application and, in some cases, transmit the application to the clearance department 16 for review and release.

FIG. 5F is a screen shot showing an illustrative account review screen of the representative interface 30. The account review screen, which can be accessed, for example, by selecting the ACCOUNT REVIEW icon button 134 on the toolbar 128, can include a VIEW ACCOUNTS section 206 for displaying a list of those accounts to be reviewed. For each client account listed under section 206, the representative may select the appropriate box or boxes 208 on the display screen 116, prompting the program 12 to display further information for those accounts. If desired, the selected account information can be outputted in either an XML grid format via icon button 210, or a printer-friendly format via icon button 212. An ATTACH DOCUMENTS icon button 214 can be selected to upload any documents to be associated with the account application.

If the representative wishes to view more information regarding one or more selected accounts, the representative may select a GO TO DST VISION icon button 216 on the display screen 116, causing the program 12 to query the intermediary program 34 for additional account and/or trade information, including account balances, account positions, transaction histories, fund pricing and yields, and/or hypothetical back-end redemption charge calculations across one or more fund companies. Selection of icon button 216 may be used, for example, to view the account balances for funds held at multiple mutual fund companies. The information received via the intermediary program 34 can then be provided on the display screen 116 for review.

FIG. 5G is a screen shot showing an illustrate trade ledger screen of the representative interface 30. The trade ledger screen, which may be accessed, for example, by selecting the TRADE LEDGER icon button 136 on the toolbar 128, can include a TRADE LEDGER section 218 for viewing trade ledgers for each account generated. A number of selection bars and boxes 220,222,224 can be provided in the TRADE LEDGER section 218 for viewing trade activity occurring within a certain date range. A VIEW selection bar 220, for example, can be used to select the types of trades to be viewed. A BEGINNING DATE text box 222 and ENDING DATE text box 224, in turn, can be provided to select the beginning and ending dates in which to view trading activity. Once the representative has entered the desired trade type and dates via buttons 220,222,224, the representative may select a CREATE REPORT icon button 226 on the display screen 116, prompting the program 12 to generate a trade ledger report.

FIG. 5H is a screen shot showing an illustrative compensation screen of the representative interface 30. The compensation screen, which may be accessed, for example, by selecting the COMPENSATION icon button 138 on the toolbar 128, can include a TRADES NOT PAID section 228 and a PAYOUT VERIFICATION section 230. The TRADES NOT PAID section 228 may include, for example, a list of those trades that have not been paid out to the fund company. The PAYOUT VERIFICATION section 230, in turn, may include a BEGINNING DATE text box 232 and an ENDING DATE text box 234 that can be used to generate a list of those payouts occurring in a particular date range. Generation of a list of payouts that have been made within a particular date range may be made, for example, by entering a desired date range in text boxes 232 and 234 and then selecting a GO icon button 236 on the display screen 116, prompting the program 12 to display a list of payouts that have been made.

FIGS. 5I and 5J are several screen shots showing a workflow screen of the representative interface 30. The workflow screen, which can be accessed, for example, by selecting the WORKFLOW icon button 140 on the toolbar 128, can include a VIEW section 238 having a selection bar 240 that can be used to select the type of account or accounts to be viewed along with a number of text boxes 242,244 that can be used to designate a desired date range for viewing. Example accounts that can be selected via the selection bar 240 can include, for example, those applications that have not been approved, those accounts that have been approved, and/or those accounts that have been cancelled. As shown in both FIGS. 5I and 5J, selection of “All Accounts in Workflow” on the selection bar 240 causes the computer program 12 to display an APPLICATIONS NOT APPROVED section 246, an APPLICATIONS APPROVED section 248, and a CANCELLED APPLICATIONS section 250. It should be understood, however, that only certain sections may be displayed on the display screen 116 by selection of the appropriate text using the selection bar 240.

The APPLICATIONS NOT APPROVED section 246 may include a list of those accounts that have not been approved or require further action by the representative before processing. For each account listed under this section 246, an error code and short message 252 (e.g. “123-Financial Objected Not Suited”) may be provided indicating the reason or reasons for the account not being accepted along with a message 254 indicating a suggested action to be taken on the account. An EDIT AND RESUBMIT icon button 256 for each account listed may be selected to edit the application information and resubmit the application for review, if desired. A CANCEL icon button 258, in turn, can be used to cancel the review process for that account.

The CANCELLED APPLICATIONS section 250 may include a list of those accounts that have been cancelled. For each account listed under this section 250, an error code and short message 260 (e.g. “124 Bank Information Is Not Complete”) may be provided indicating the reason or reasons for the disapproval or rejection of the account along with a message 262 indicating a suggested action to be taken. An EDIT AND RESUBMIT icon button 264 for each account listed may be selected to edit the application information and resubmit the application for review, if desired.

FIG. 5K is a screen shot showing an illustrative client review screen of the representative interface 30. The client review screen, which can be accessed, for example, by selecting the CLIENTS icon button 142 on the toolbar 128, can include an EDIT CLIENT INFORMATION section 266 containing a list of the representative's existing clients. The representative may select either the name of an existing client to change the client's information, or alternatively, may select a CREATE A CLIENT icon button 268 on the display screen 116 to create a new account application, similar to that discussed above, for example, with respect to FIGS. 5C-5E. If desired, the representative may also select an IMPORT CLIENT LIST icon button 270 on the display screen 116 to import a list of clients. Selection of icon button 270 may be used, for example, to upload a spreadsheet file or database file containing a list of existing clients to be managed using the program 12.

FIG. 5L is a screen shot showing an illustrative document management screen of the representative interface 30. The document management screen, which can be accessed, for example, by selecting the DOCUMENTS icon button 144 on the toolbar 128, can include a SELECT ACCOUNT section 272 and an ATTACH DOCUMENT section 274. The SELECT ACCOUNT section 272 may be used to select one or more accounts in which the representative desires to perform document management. For each account selected, the ATTACH DOCUMENT section 274 can be used by the representative to upload necessary documents required by the broker-dealer and/or the fund company. A DOCUMENT TYPE selection bar 276 can be used to indicate the type of document to be uploaded. If, for example, the account is a trust or estate account, the representative may select the text “Trust Document” using the selection bar 276, as shown. A NAME OF FILE text box 278 and LOCATION selection box 280 may prompt the representative to enter a name of the file and the storage location of the original document. Once the representative has entered these fields, the representative may select a RETRIEVE DOCUMENT icon button 282 on the display screen 116 to upload the document.

FIG. 5M is a screen shot showing an illustrative user editing screen of the representative interface 30. The editing screen, which can be accessed, for example, by selecting the EDIT USER icon button 146 on the display screen 116, can be used for editing information for any clients, additional owners, and/or beneficiaries of an account. As shown in FIG. 5M, for example, the user editing screen can be configured to display an ADDITIONAL OWNER section 284 providing information for any additional owners listed on the account If the representative desires to make any changes to the information, the representative may select an EDIT icon button 286 on the display screen 116. The program 12 may then prompt the representative to make the desired changes to the account.

FIGS. 5N-5P are several screen shots showing several illustrative fields that can be used for creating an electronic account application using the representative interface 30. The screens depicted in FIGS. 5N-5P may be accessed, for example, by selecting the ADD A NEW CLIENT icon button 158 on the screen depicted in FIG. 5C, and can include a SELECT CLIENT TYPE section 288, an IDENTIFICATION section 290, a SOURCE OF FUNDS section 292, and in some cases such as for corporate clients, an AFFILIATIONS section 294. Other sections in addition to or in lieu of those shown in FIGS. 5N-5P may also be provided depending on the type of information gathered by the broker-dealer.

The SELECT CLIENT TYPE section 288 can include a selection bar 296 for designating the type of client for the application. As shown in FIG. 5N, for example, the representative may select the text “Person” on the selection bar 296 to indicate that the account to be created is an individual account. Other client types such as “Corporate” or “Trust” may also be selected via the selection bar 296, as appropriate. Once the representative has selected the desired client type, the program 12 can be configured to display several entry fields used to identify the client. For an individual account, for example, a number of text boxes 298,300,302,304,306 may be used to enter the individual's name along with their social security number and date of birth. A CITIZENSHIP selection bar 308 can be provided on the display screen 116 to designate the individual's citizenship and/or nationality. A series of text boxes 310,312 in section 288 can be used to designate the individual's legal and mailing address. If the mailing address is the same as legal address, the representative may select an icon box 314, causing the program 12 to automatically fill in the entry fields into the text boxes 312 for the mailing address. A number of text boxes 316 can be used to enter contact information for the client, including the client's home phone number, work phone number, mobile phone number, facsimile number, and E-mail address.

The IDENTIFICATION section 290 can be used to enter identification information required for creating the application. As shown in FIG. 5O, for example, the IDENTIFICATION section 290 can include a selection bar 318 for indicating the type of identification to be used. If, for example, the type of client identification to be used is a driver's license, the representative may select the text “Driver's License” using the selection bar 318. Once selected, the program 12 can be configured to display a text box 310 for entering the driver's license number, a selection bar 322 for indicating the issue state of the driver's license, an issue date box 324, and an expiration date box 326. The program 12 may prompt the representative to enter other information that can be used to identify the client including, for example, a selection bar 328 for designating the client's marital status and a text box 330 for designating any dependents of the client.

The SOURCE OF FUNDS section 292 can be used to specify the client's source of funds. As can be further seen in FIG. 5O, for example, the SOURCE OF FUNDS section 292 can include several text boxes and/or selection bars 332,334,336,338,340 for entering the client's bank information, including the bank name, account number, branch/city, state, and Zip Code. The SOURCE OF FUNDS section 292 may further include a number of text boxes and/or selection bars 342-344, 346,348,350,352,354,356,358 for entering the client's financial and job information, including, for example, the client's employment status, source of income, occupation, employer name, and employer address.

The AFFILIATIONS section 294 can be used by the representative to associate any affiliations attributes for each owner of the account. For a corporate client, and as shown, for example, in FIG. 5P, the AFFILIATION section 294 can include a number of selection boxes 360 for indicating whether the client is affiliated with a stock exchange, is a member firm of an exchange, is an NASD securities broker-dealer, is a municipal securities broker-dealer, or is a control person. For each item selected, the representative may enter the name of the company/organization using a number of text boxes 362 provided on the display screen 116. The AFFILIATIONS section 294 can also include a number of text boxes that can be used to specify the company's name and trading symbol. An icon button 368 may be selected to add a company to the list of affiliations, if desired.

Once the representative has filled in the entry fields provided under each section 288,290,292,294, the representative may then select an icon button 370 on the display screen 116, causing the program 12 to save the information and then go the application screen of FIG. 5C, prompting the representative to complete the remainder of the application.

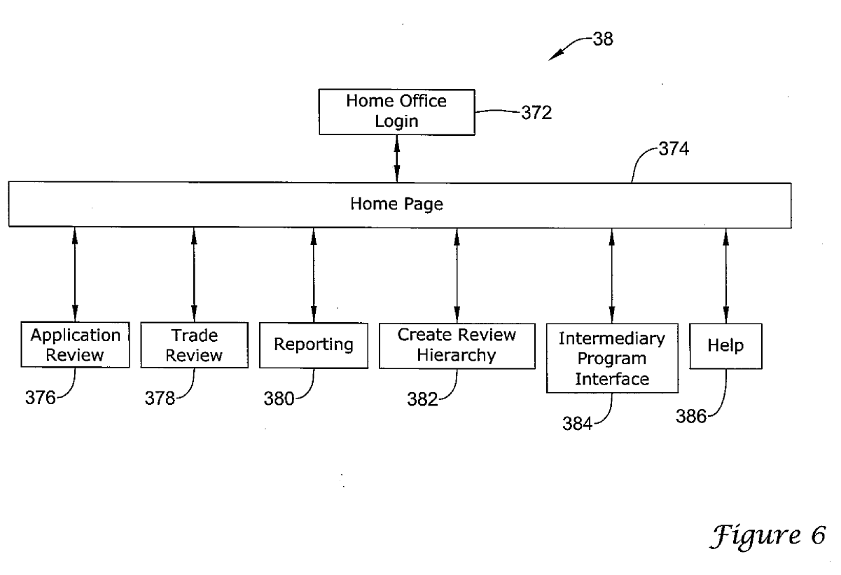

FIG. 6 is a diagrammatic view showing illustrative functionality that can be provided to supervisors 40 via the home office interface 38 of FIG. 1. As shown in FIG. 6, the home office interface 38 can include a login screen 372 prompting a supervisor to enter the user firm's name, a user ID number (e.g. broker-dealer CRD number), and a user password to gain access to the home office functionality described above with respect to FIG. 1. The home office interface 38 may be accessed, for example, by a supervisor 40 logging into their account via a computer equipped with a display screen. Once logged into their account, the program 12 can be configured to display a HOME PAGE screen 374 providing a list of action items that require action along with a list of options that may be selected to accomplish such actions. Other information may also be displayed on the HOME PAGE screen 374, if desired.

From the HOME PAGE screen 374, the user may access various back office program functionality, including an APPLICATION REVIEW module 376, a TRADE REVIEW module 378, a REPORTING module 380, a CREATE REVIEW HIERARCHY module 382, a INTERMEDIARY PROGRAM INTERFACE module 384, and a HELP module 386. Each module may represent, for example, a separate screen or screens on a graphical user interface (GUI) that can be accessed by the supervisor 40 via the home office interface 38.

The APPLICATION REVIEW module 376 can be used by a supervisor 40 to review any electronic account applications submitted for compliance and suitability review by their representatives 24. In some embodiments, for example, the APPLICATION REVIEW module 376 may provide the supervisor 40 with a list of any priority accounts, new accounts, and/or parked accounts that require reviewing prior to submission to the fund company 30. By selecting one or more accounts from these lists, the supervisor 40 may then review the accounts and, if necessary, make any necessary corrections to the account information and/or send the account back to the representative 24 for further action. The supervisor 40 may reject the account, for example, by selecting from a list of pre-determined errors, or, alternatively, by manually entering a message indicating to the representative 24 the problem with the account and the appropriate follow-up action to be taken, if any. If, for example, the supervisor 40 rejects the application based on suitability, the supervisor 40 may select from a pre-determined error code using the APPLICATION REVIEW module 376. The program 12 can then be configured to send the application back to the representative 24 for further action vis-à-vis the representative interface 30.

The TRADE REVIEW module 378 can be used by a supervisor 40 to perform workflow relating to trades initiated by their representatives 24. The module 378 may be used, for example, to review and release any trade requests and to verify the existence of funds in the account for the payment of those trade requests. The TRADE REVIEW module 378 can be used to perform other functions, including but not limited to, reviewing any letters of intent, reconciling any A/B share issues or rules, and reconciling any breakpoint rules.

The REPORTING module 380 can be used by a supervisor 40 for performing reporting functions on accounts. The module 380 may be used, for example, for reviewing any reports of accounts that are not in good order, including review times, error codes, and/or representative or office errors. The REPORTING module 380 may be used to perform other functions such as reviewing trade blotters, breakpoints, account data per representative or clients, commissions, deposits/ledgers, aging reports, account matching, record matching, exceptions reporting for accounts established outside of the review process, and OFAC checks for new accounts. In some embodiments, for example, the REPORTING module 380 may be used by a supervisor 40 to automatically match all accounts that are attached as a household based on Social Security Number to ensure that no duplicated accounts are allowed.

The CREATE REVIEW HIERARCHY module 382 may be used by a supervisor 40 to create and maintain a control hierarchy of representatives, financial advisors, and/or other such users for principal review of accounts and trades. In some embodiments, for example, the CREATE REVIEW HIERARCHY module 382 may be used by a compliance manager to generate a hierarchical control list of all supervisors and their corresponding representatives responsible for monitoring client accounts and trades. The hierarchical control list may then be used to provide principal review over accounts and/or trades based on certain representatives, groups, accounts, funds, or other such control field. For example, the hierarchical control list may be used to view a list of accounts and corresponding representatives in which a particular supervisor or group of supervisors is responsible for.

The INTERMEDIARY PROGRAM INTERFACE module 384 may be used by supervisors 40 to access an intermediary enterprise data aggregation program such as DST Vision® or the like to view account balances, account positions, transaction histories, fund pricing and yields, hypothetical back-end redemption charge calculations and other such information across one or more multiple fund companies 30. Other functionality such as generating appraisals, performance reporting, and asset allocation reporting may also be generated and viewed via the module 384.

The HELP module 386 can be used by supervisors 40 to obtain additional information regarding the program 12. For example, from the HELP module 386, the supervisor 40 may access an electronic user manual, view training videos on the functionality of the program 12, perform a quick review of the program 12, and view a list of frequently asked questions (FAQ's). In some cases, additional instructional and/or training information for performing supervisory or other back-office duties can also be accessed via the HELP module 386, if desired.

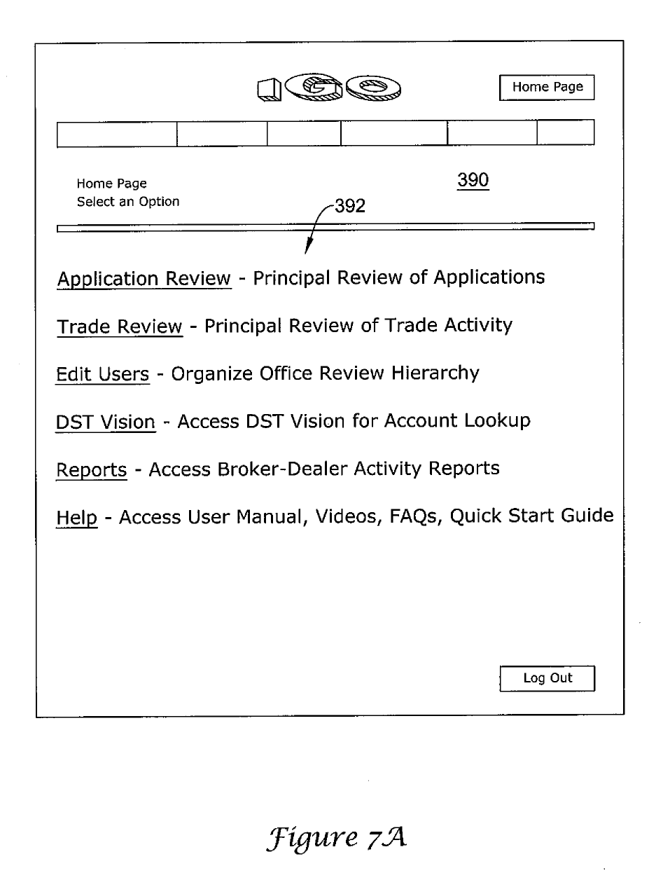

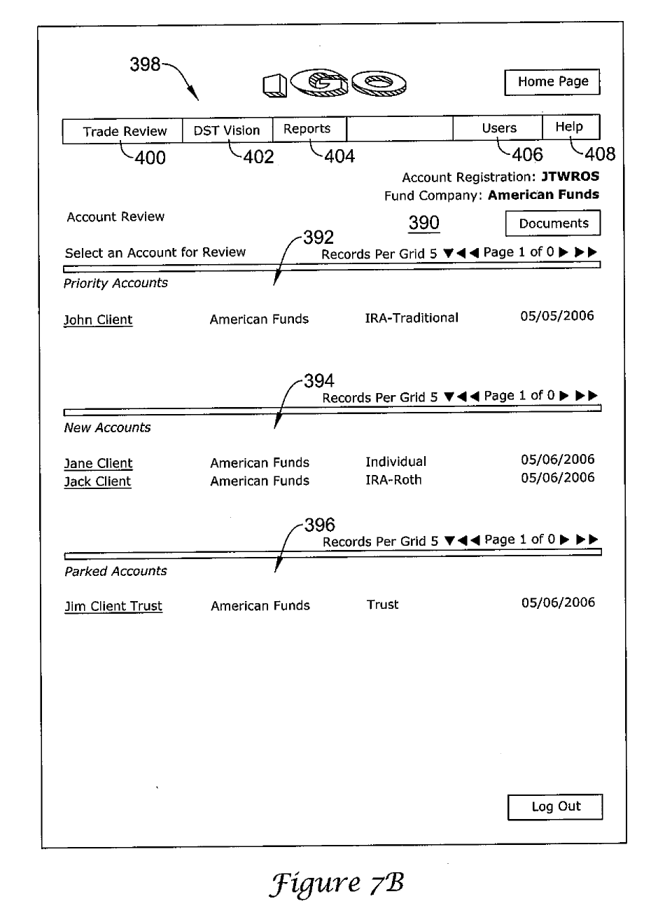

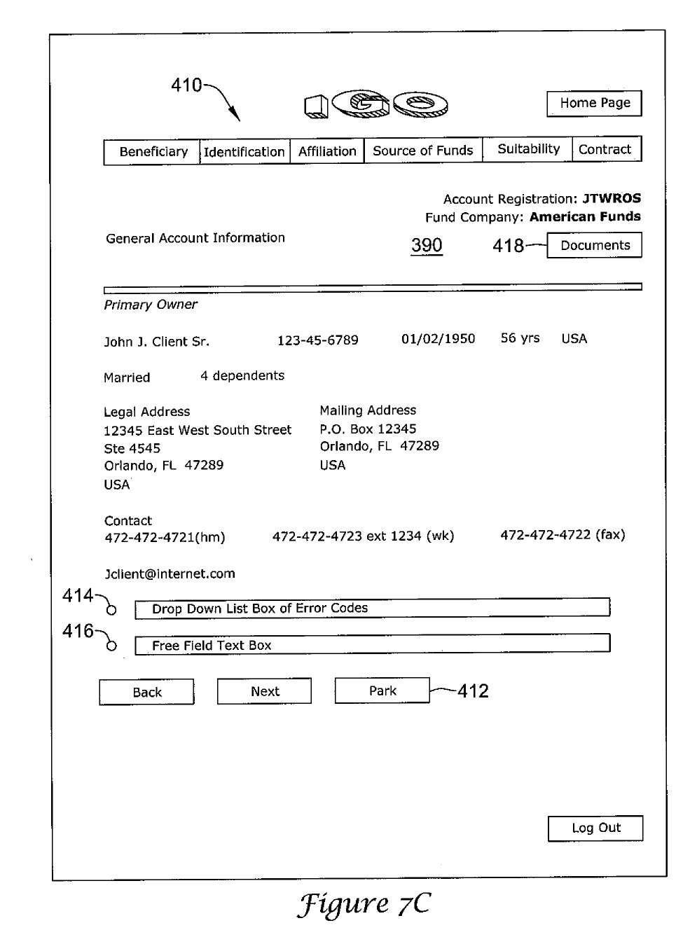

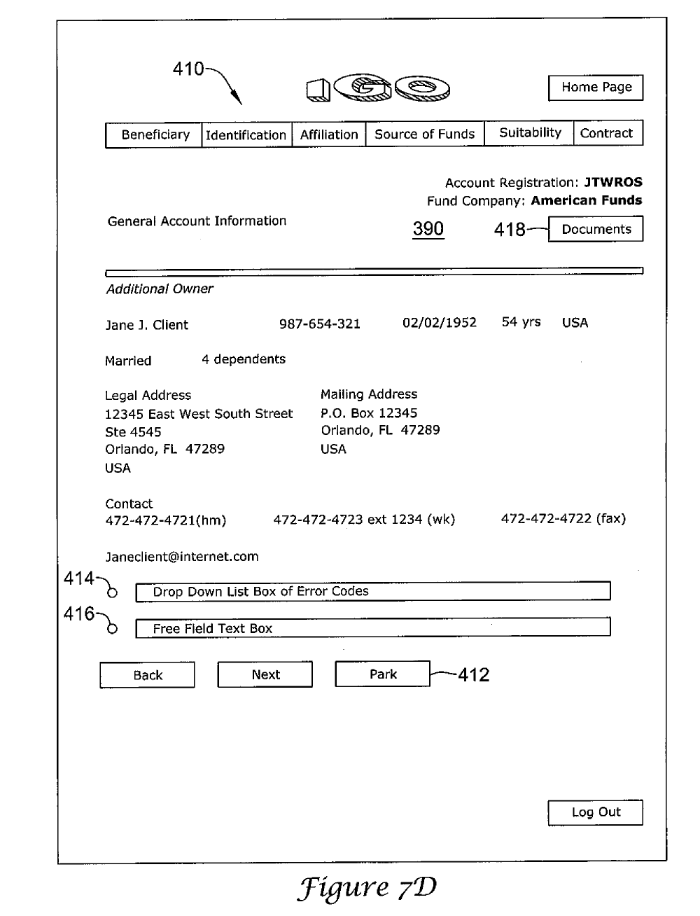

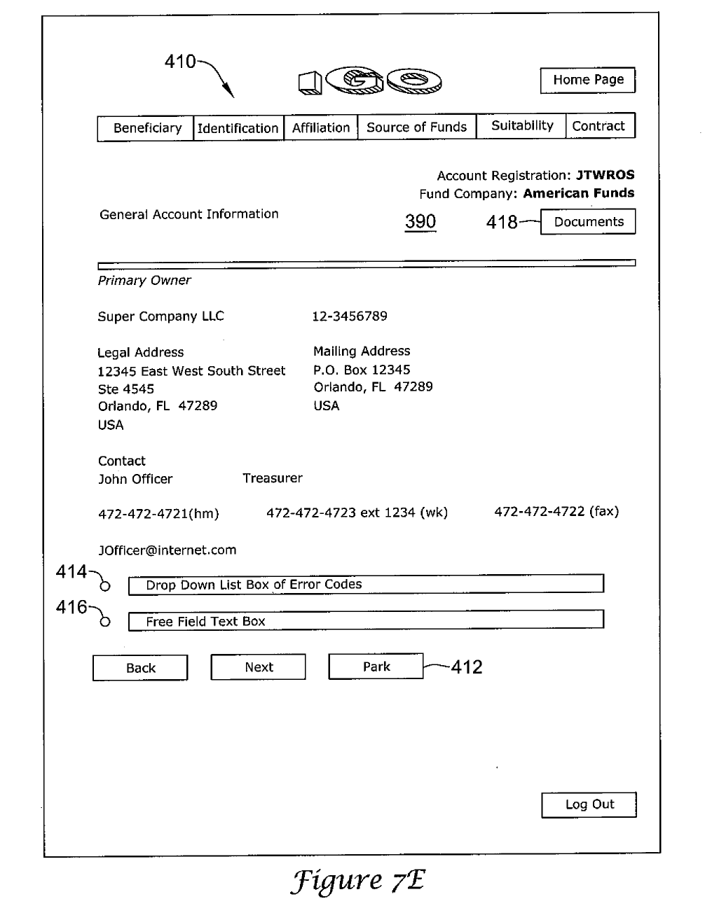

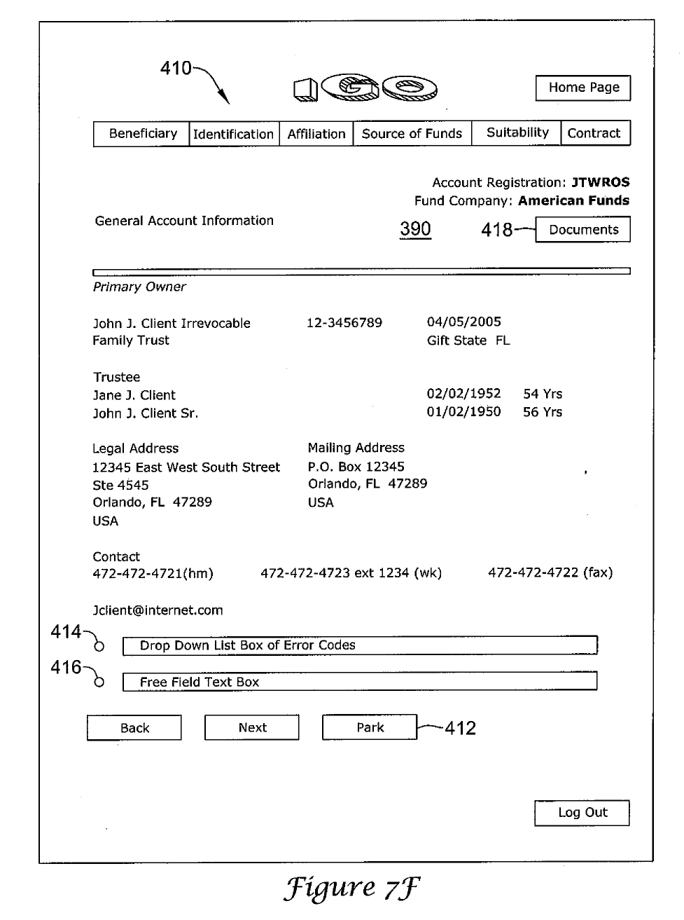

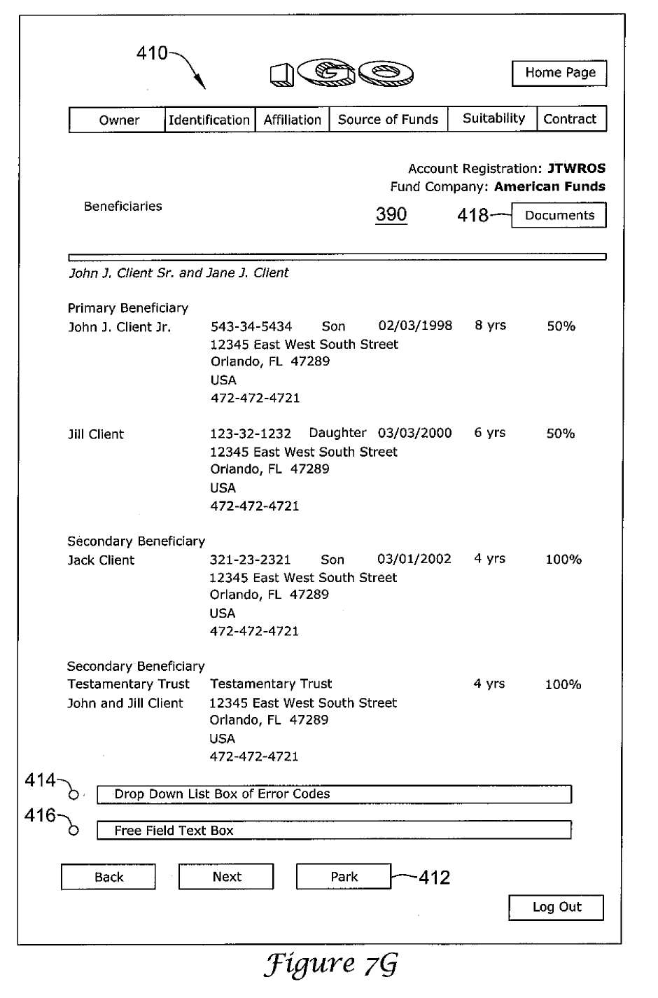

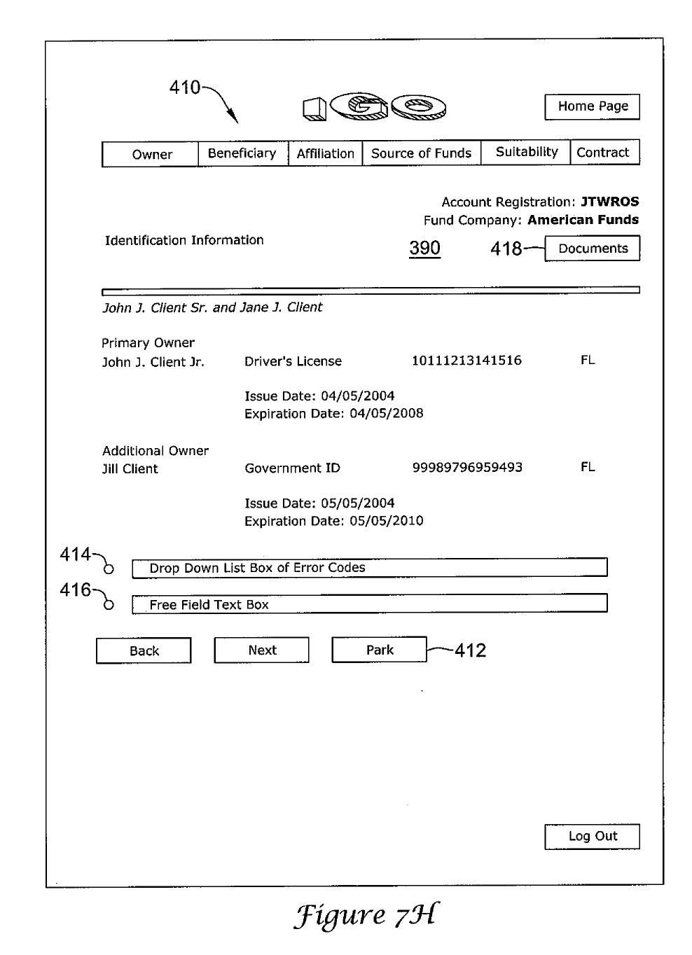

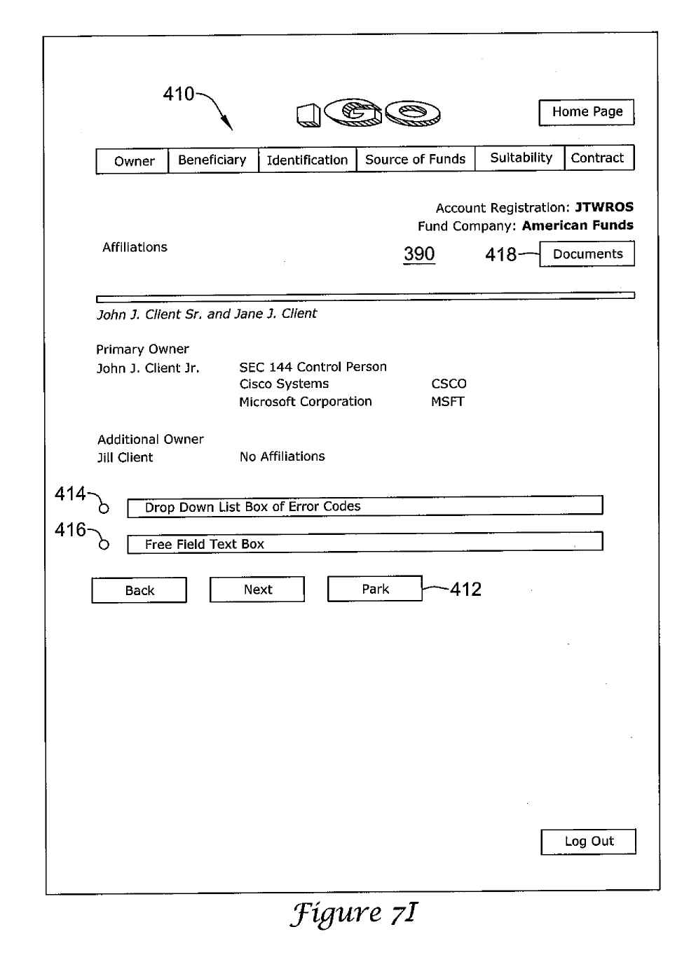

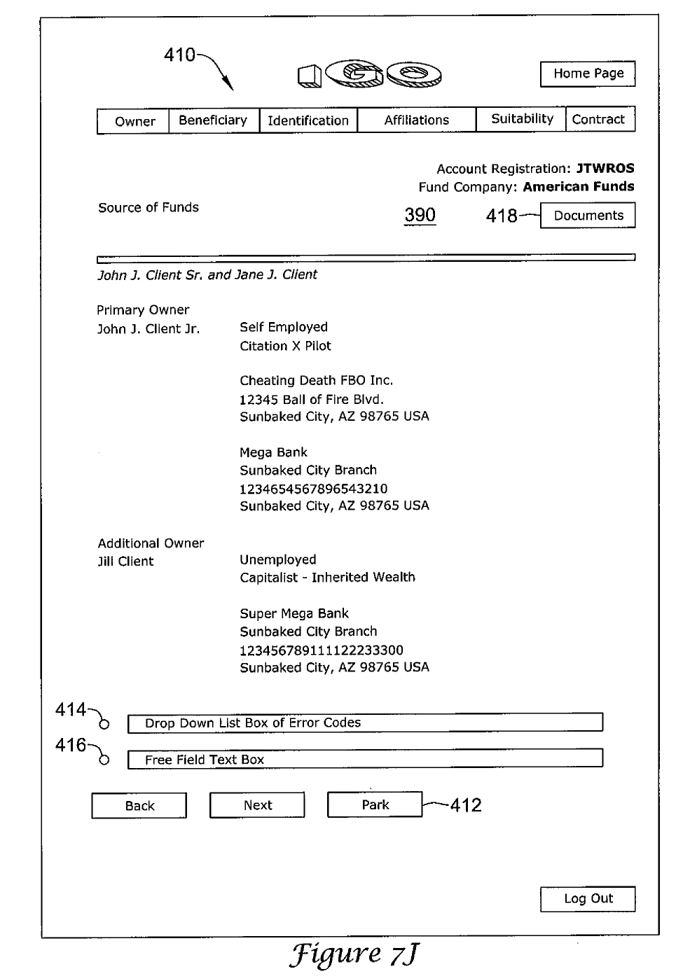

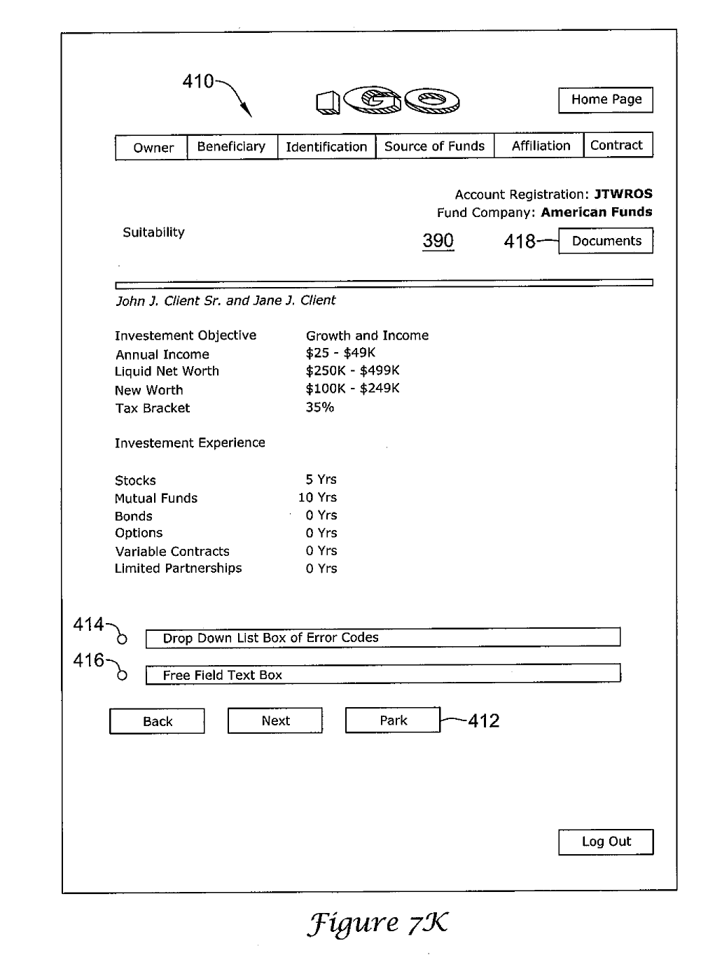

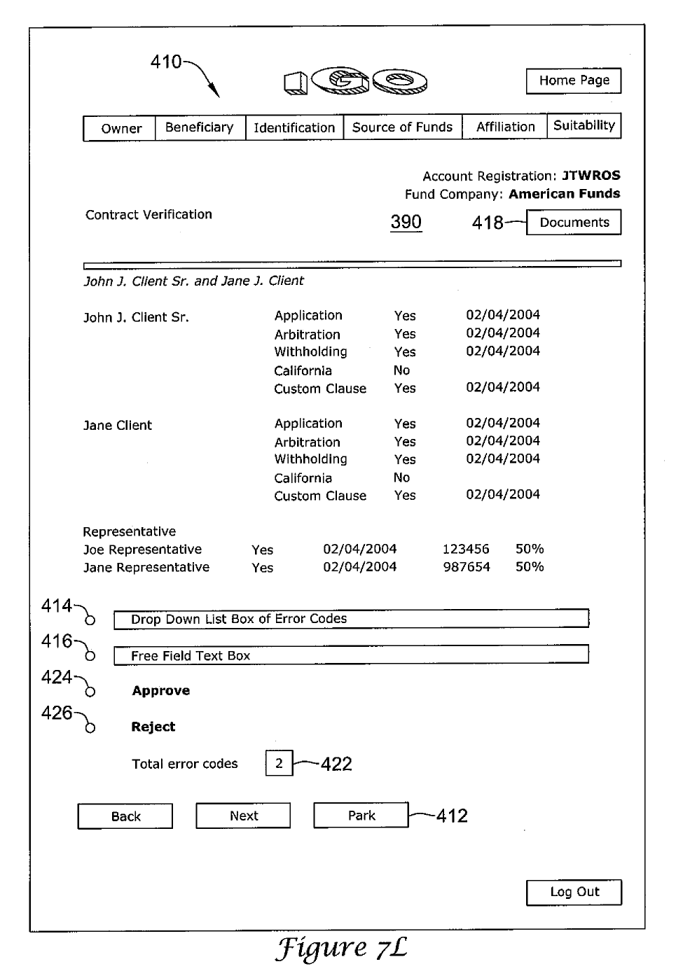

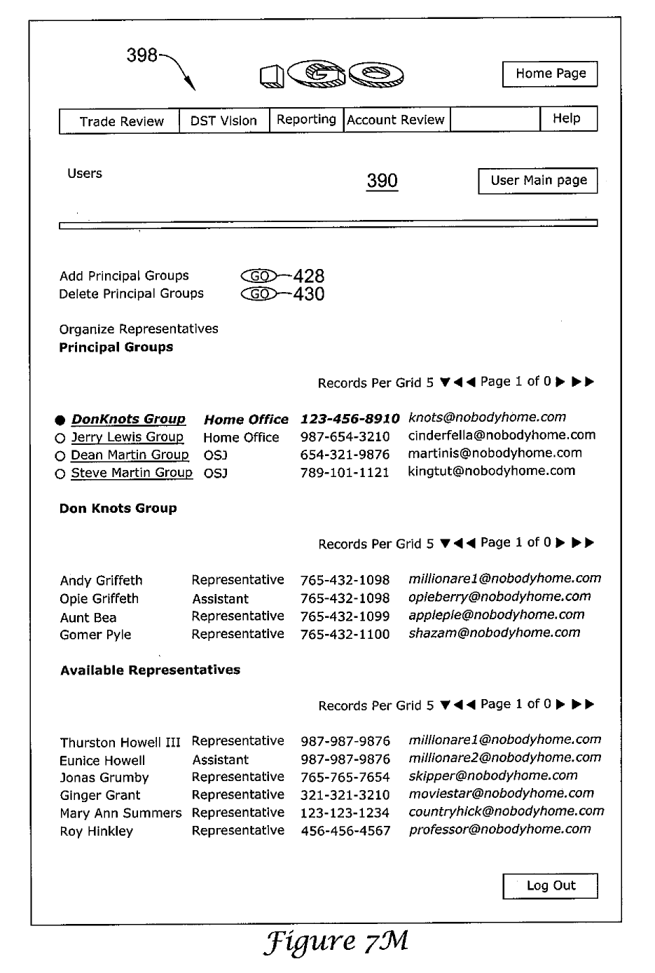

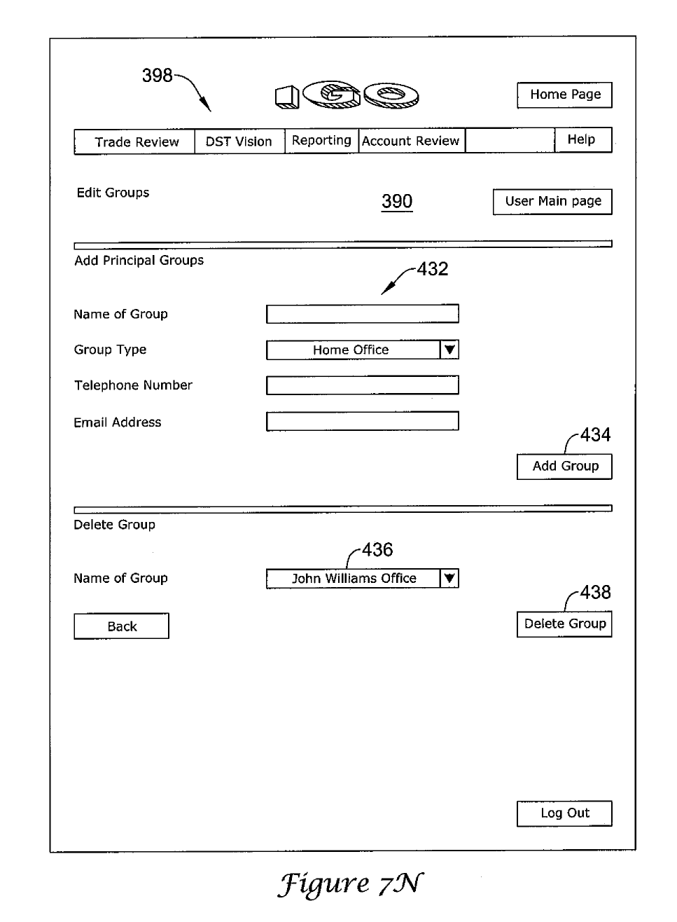

FIGS. 7A-7N are several screen shots showing an illustrative graphical user interface for the home office interface 38 of FIG. 1. FIGS. 7A-7N may represent, for example, a graphical user interface that can be accessed on a supervisor's computer, personal digital assistant (PDA), or other such device.

FIG. 7A is a screen shot showing an illustrative home page screen that can be display on the user's display screen 390. The home page screen may represent, for example, one or more display screens that can be presented to the supervisor 40 upon entering their firm CRD number, user login name, and password. As shown in FIG. 7A, the computer program 12 can be configured to display a list 392 of options that can be performed via the home office interface 38. The options may correspond, for example, to the various modules described herein with respect to FIG. 6, or may vary from that described herein.

FIG. 7B is a screen shot showing the display screen 390 upon the selection of the “Application Review” link in FIG. 7A. As shown in FIG. 7B, selection of the “Application Review” link can cause the computer program 12 to display a list of accounts that can be reviewed by the supervisor, including a PRIORITY ACCOUNTS section 392 listing those accounts that require immediate attention, a NEW ACCOUNTS section 394 listing those accounts that have been recently created, and a PARKED ACCOUNTS section 396 listing those accounts that have been parked and require additional review.

A toolbar 398 provided on the display screen 390 can be used to access additional functionality of the home office interface 38. The toolbar 398 can include, for example, a TRADE REVIEW icon button 400 for viewing and screening trades and confirmations, a DST VISION icon button 402 for accessing the third-party intermediary program functionality, a REPORTS icon button 404 for viewing and generating reports and blotters, a USERS icon button 406 for viewing and editing information of those users of the program 12, and a HELP icon button 408 for providing the supervisor with instructional and program training.

From each section 392,394,396 on the display screen 390, the supervisor 40 may select the name of the desired client, prompting the program 12 to display more information for that selected client. For example, selection of a client link on the display screen 390 can be used to view further information about the client, including, but not limited to, the primary owner of the account, any additional owners of the account, any beneficiaries of the account, the identification information for the client, any affiliation information for the client, the source of funds for the account, suitability information for the client, and any contract verifications required for the account. A toolbar 410 provided on the display screen 390 may be used to link to a separate screen or screens for each of these functions.

FIGS. 7C and 7D are several illustrative screen shots showing the display of the primary and additional owners for a selected individual account. As shown in FIGS. 7C an 7D, the selection of a client link on the display screen 390 depicted in FIG. 7B can cause the program 12 to display additional information about the client, including their legal and mailing address, contact information, age, citizenship, marital status, number of dependents, and Social Security Number. Other information in addition to, or in lieu of that shown may also be provided on the display screen 390, if desired. Several illustrative screen shots showing exemplary account information that can be displayed for corporate and trust clients is further shown, for example, in FIGS. 7E and 7F, respectively.

The supervisor 40 may review the account for accuracy and, if necessary, select a PARK icon button 412 to park the account if further review by the representative 24 is deemed necessary. The reason or reasons for parking the account may be specified via a number of icon selection buttons 414,416, allowing the supervisor 40 to select from a pre-determined list of error codes and/or by entering the reason or reasons manually in a text box. Selection of icon button 414, for example, can prompt the program 12 to display a list of error codes that can then be selected. A DOCUMENTS icon box 418 may be selected to view any documents associated with the account.

FIGS. 7G-7L are several screen shots showing additional information that can be viewed for each client using the home office interface 38. FIG. 7G may represent, for example, an illustrative screen showing the beneficiaries of a trust account. FIGS. 7H-7L, in turn, may represent several illustrative screens showing the identification information, affiliations, source of funds, suitability information, and contract verification information for an illustrative trust client. As can be seen in FIG. 7L, an error code box 422 on one of the screens may display the number of error codes (e.g. “2”) contained in the application. Once the supervisor 40 has completed reviewing the entire application, including any errors indicated by box 422, the supervisor 40 may then select either an ACCEPT icon button 424 to accept the application or a REJECT icon button 426 to reject the application.

FIG. 7M is a screen shot showing the display screen 390 upon the selection of the USERS icon button 406 in FIG. 7B. As shown in FIG. 7M, selection of the USER icon button 406 can prompt the program 12 to display a list of principal groups and available representatives that can be organized into a control hierarchy, allowing the supervisor 40 to view all activity based on particular representatives, representative assistants, groups of representatives and assistants, and/or other desired criteria. From the screen depicted, for example, in FIG. 7M, the supervisor 40 may select from an existing group displayed on the display screen 390 for review and/or editing, may add a new group by the selection of icon button 428, or may delete an existing group by the selection of icon button 430.

FIG. 7N is a screen shot showing an illustrative display screen 390 that can be used to edit and/or delete hierarchical groups created using the home office interface 38. As shown in FIG. 7N, if the supervisor 40 desires to add a new group for review, the supervisor 40 may enter the name of the group, the type of group (e.g. home office, satellite office, regional office, etc.), and the telephone number and E-mail address of the individual creating the group using a number of text and/or selection boxes 432. Once entered, the supervisor 40 may then select an ADD GROUP icon box 434 on the display screen 390 to create the group. Conversely, if the supervisor 40 desires to delete an existing group, the supervisor 40 may select the desired group via a selection bar 436 and then delete the group by selecting a DELETE GROUP icon button 438 on the display screen 390.

FIG. 8 is a diagrammatic view showing an illustrative control hierarchy 440 that can be created using the home office interface 38 of FIG. 1. The control hierarchy 440, illustratively a three-tier control hierarchy for principal review over a home office 442, can include a number of supervisors 444,446 each responsible for a number of respective representatives 448,450 and 452,454. Using the control hierarchy 440 illustrated in FIG. 8, a compliance manager or other such individual responsible for compliance management may elect to view accounts or trades for one or more representatives 448,450,452,452 and/or supervisors 444,446 within the hierarchy 440 for compliance screening.

If, for example, the compliance manager desires to view those accounts and trades associated with a certain client or clients 456a-456h, the manager may access the home office interface 38, select a desired client for review, and then view those representatives 448,450,452,454 and/or supervisors 444,446 responsible for the account. If the compliance manager desires to view accounts and trades associated with clients 456a and 456g, for example, the manager may select those client's accounts using the home office interface 38, prompting the computer program 12 to display the representatives 448,454 and/or supervisors 444,446 responsible for managing those clients' accounts.

Although the illustrative control hierarchy 440 shown in FIG. 8 is a three-tier hierarchy (e.g. N=3) having a supervisory level tier, a representative level tier, and a client level tier, it should be understood that the hierarchy 440 created may include any number of different tiers (e.g. N=2, 4, 5, 6, 7, etc.), either vertically or horizontally, depending on the unique control structure of the firm. If, for example, the financial services firm has multiple regional offices that report to a central home office, an additional vertical tier may be added to the control hierarchy 440 to permit the compliance manager to review client accounts, representatives, and supervisors based on their respective regional office or offices.

In use, the control hierarchy 440 allows each representative 448,450,452,454 and supervisor 444,446 to be linked together in a hierarchical manner, allowing the compliance manager to better review trends occurring at both the representative and supervisory levels. For example, the ability to link each representative 448,450 and supervisor 444,446 may facilitate workflow and principal review over client accounts and trades managed by a financial services firm, both in the aggregate and relationally. The ability to capture client account data electronically via an application wizard of the computer program, for example, may facilitate workflow and compliance screening of client accounts and trades by those firms that provide financial services products directly from multiple fund companies and without a separate clearance firm.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes can be made with respect to various elements described herein without exceeding the scope of the invention.

What is claimed is:

1. A system for performing compliance and account management of client accounts by a financial services firm, the system comprising:
a number of representatives each having one or more clients;
a compliance department including a number of supervisors each having supervisory review over one or more client accounts managed by the representatives;
a compliance and account management computer program for generating electronic account applications for the one or more client accounts and transmitting the electronic account applications to one or more fund companies for the purchase of funds, the computer program including a hierarchical rules engine for creating an electronic control hierarchy for use in providing principal review over accounts and trades requested by the representatives; and
a database for storing client account data.

2. The system of claim 1, wherein the computer program includes a representative interface and a home office interface.

3. The system of claim 2, wherein the representative interface and home office interface each include a graphical user interface of the computer program.

4. The system of claim 2, wherein the representative interface includes an application creation module for creating an electronic account application for each client account.

5. The system of claim 2, wherein the representative interface includes one or more modules selected from the group of modules consisting of an application creation module, a trade engine module, an account workflow module, a trade blotter module, a compensation module, a client management module, an account document management and storage module, a user setup module, and a help module.

6. The system of claim 2, wherein the home office interface includes a control review hierarchy module for creating electronic control hierarchies for identifying accounts and/or trades based on the representative and/or supervisor responsible for those accounts and/or trades.

7. The system of claim 2, wherein the home office interface includes one or more modules selected from the group of modules consisting of an application review module, a trade review module, a reporting module, a control review hierarchy module, an intermediary program interface module, and a help module.

8. The system of claim 2, wherein the home office interface includes a module for performing suitability screening of client accounts.

9. The system of claim 2, wherein the computer program includes a module for confirming the name and licensing status of the representatives.

10. The system of claim 2, wherein the representative and home office interfaces are customizable.

11. The system of claim 1, wherein the financial services firm is a broker-dealer, and wherein the compliance department is a back-office compliance department within the broker dealer.

12. The system of claim 1, wherein the electronic account applications are transmitted directly to the one or more fund companies.

13. The system of claim 12, further comprising an intermediary program adapted to permit representatives and supervisors to view client account data and perform householding functions across multiple fund companies.

14. The system of claim 13, wherein the intermediary program is adapted to provide account aggregation of client accounts across multiple fund companies.

15. The system of claim 1, wherein the computer program includes a search engine for searching client account data contained within the database.

16. The system of claim 15, wherein the search engine includes a means for searching client accounts by client name and/or account number.

17. A method of managing client accounts by a financial services firm, the financial services firm including a number of representatives each having one or more clients and a compliance department including a number of supervisors each having principal review over the client accounts, the method comprising the steps of:
creating an electronic data package using a computer program, the electronic data package including an account application containing account information for one or more clients desiring to purchase funds through one or more fund companies associated with the financial services firm;
transmitting the electronic data package to a supervisor within the compliance department responsible for reviewing client accounts and trades;
reviewing the electronic data package for the presence of any errors or flags, wherein the step of reviewing the electronic data package includes the step of screening the account application for suitability;
providing an approval or disapproval of the account application and prompting a representative to take further action if the account application contains one or more errors and/or flags; and
transmitting the electronic data package directly to one or more fund companies for processing.

18. The method of claim 17, wherein the step of creating an electronic data package is performed by a representative using a representative interface of the computer program.

19. The method of claim 17, wherein the step of reviewing the electronic data package for the presence of any errors or flags is performed by a supervisor using a home office interface of the computer program.

20. The method of claim 17, wherein the step of transmitting the electronic data package to one or more fund companies for processing includes the steps of:
converting the electronic data package into an XML format via an XML interface of the computer program; and
transmitting the converted electronic data package to the one or more fund companies via an intermediary program.

21. The method of claim 20, wherein the step of transmitting the converted electronic data package to the one or more fund companies is accomplished without a clearance firm.

22. The method of claim 17, wherein the steps of creating, reviewing, and transmitting the electronic data package are accomplished electronically via the computer program.

23. The method of claim 17, wherein the step of reviewing the electronic data package for the presence of any errors or flags is accomplished without a third-party compliance firm.

24. The method of claim 17, wherein the one or more fund companies further receive and process the transmitted electronic data package and send a confirmation back to the computer program indicating whether the requested trade was successful.

25. A computer program executable on a computer readable medium and adapted to provide compliance and account management of client accounts by a financial services firm, the financial services firm including a number of representatives each having one or more clients and a compliance department including a number of supervisors each having principal review over the client accounts, the computer program comprising:
a representative interface for generating electronic account applications for one or more clients and transmitting the electronic account applications directly to one or more fund companies for the purchase of funds; and
a home office interface for reviewing the electronic account applications.

26. The computer program of claim 25, wherein the representative interface and home office interface each include a graphical user interface.

27. The computer program of claim 25, wherein the representative interface includes one or more modules selected from the group of modules consisting of an application creation module, a trade engine module, an account workflow module, a trade blotter module, a compensation module, a client management module, an account document management and storage module, a user setup module, and a help module.

28. The computer program of claim 25, wherein the home office interface includes a control review hierarchy module for creating electronic control hierarchies for identifying accounts and/or trades based on the representative and the supervisor responsible for principal review over the accounts and/or trades.

29. The computer program of claim 25, wherein the home office interface includes one or more modules selected from the group of modules consisting of an application review module, a trade review module, a reporting module, a control review hierarchy module, an intermediary program interface module, and a help module.

30. The computer program of claim 25, wherein the home office interface includes a module for performing suitability screening of client accounts managed by the representatives.

31. The computer program of claim 25, wherein the computer program includes a module for confirming the name and licensing status of the representatives.

32. The computer program of claim 25, wherein the representative and home office interfaces are customizable.

33. The computer program of claim 25, wherein the computer program includes a search engine for searching client account data.

34. The computer program of claim 33, wherein the search engine includes a means for searching client accounts by client name and/or account number.

35. The computer program of claim 25, wherein the computer program includes a hierarchical rules engine for creating an electronic control hierarchy for use in providing principal review over accounts and/or trades managed by one or more different representatives within the financial services firm.
